(19) United States
(12) Patent Application Publication
(10) Pub. No.: US 2006/0229813 A1
(43) Pub. Date: Oct. 12, 2006

(54) Ionospheric forecast system (IFS)

(76) Inventor: William Kent Tobiska, Pacific Palisades, CA (US)

Correspondence Address: SPACE ENVIRONMENT TECHNOLOGIES, 1676 PALISADES DR., PACIFIC PALISADES, CA, 90272, US

(21) Appl. No.: 11/092,664

(22) Filed: Mar. 30, 2005

(51) Int. Cl. G06F 19/00

(52) U.S. Cl. 702/2

(57) ABSTRACT

The shorter-term variable impact of the Sun's photons, solar wind particles, and interplanetary magnetic field upon Earth's environment is colloquially known as space weather. Ionospheric perturbed conditions resulting from space weather can be specified in real-time or predicted using linked models and data streams based upon multi-spectral solar observations, solar wind measurements, and ionospheric measurements. This patent's concept uses an ensemble of models, combines them with operational driving data, and provides recent-past, present, and 72-hour future specification of global, regional, and local ionospheric and neutral density profiles, total electron content, plasma drifts, neutral winds, and temperatures on a 15-minute cadence. The operational Ionospheric Forecast System, as a distributed network, can detect and predict ionospheric weather as well as magnetospheric and thermospheric conditions leading to dynamical ionospheric changes. The system architecture that links models and data streams is modular, extensible, robust, and operationally reliable.

### 1. SUMMARY

The shorter-term variable impact of the Sun's photons, solar wind particles, and interplanetary magnetic field upon the Earth's environment that can adversely affect technological systems is colloquially known as space weather. It includes, for example, the effects of solar coronal mass ejections, solar flares and irradiances, solar and galactic energetic particles, as well as the solar wind, all of which affect Earth's magnetospheric particles and fields, geomagnetic and electrodynamical conditions, radiation belts, aurorae, ionosphere, and the neutral thermosphere and mesosphere. These combined effects create risks to space and ground systems from electric field disturbances, irregularities, and scintillation, for example, where these ionospheric perturbations are a direct result of space weather.

A major challenge exists to improve our understanding of ionospheric space weather processes and then translate that knowledge into operational systems. Ionospheric perturbed conditions can be recognized and specified in real-time or predicted through linkage of models and data streams. Linked systems must be based upon multi-spectral observations of the Sun, solar wind measurements by satellites between the Earth and Sun, as well as by measurements of the ionosphere such as those made from radar and GPS/TEC networks. First principle and empirical models of the solar wind, solar irradiances, the neutral thermosphere, thermospheric winds, joule heating, particle precipitation, the electric field, and the ionosphere provide climatological best estimates of non-measured current and forecast parameters. Our objective is to take an ensemble of models in these science discipline areas, move them out of research and into operations, combine them with operational driving data, including near real-time data for assimilation, and form the basis for recent past, present, and up to 72-hour future specification of the global, regional, and local ionosphere on a 15-minute basis. A by-product of this will be an unprecedented operational characterization of the “weather” in the Sun-Earth space environment.

Our unique team, consisting of small businesses, large corporations, major universities, research institutes, agency-sponsored programs, and government laboratories, combines a wealth of scientific, computer, system engineering, and business expertise that will enable us to reach our objective. Together, we have developed the concept for an operational ionospheric forecast system, in the form of a distributed network, to detect and predict the ionospheric weather as well as magnetospheric and thermospheric conditions that lead to dynamical ionospheric changes. The system will provide global-to-local specifications of recent history, current epoch, and up to 72-hour forecast ionospheric and neutral density profiles, TEC, plasma drifts, neutral winds, and temperatures. Geophysical changes will be captured and/or predicted (modeled) at their relevant time scales ranging from 15-minutes to hourly cadences. 4-D ionospheric densities (including time dimension) will be specified using data assimilation techniques coupled with physics-based and empirical models for thermospheric, solar, electric field, particle, and magnetic field parameters. The assimilative techniques allow corrections to climatological models with near real-time measurements in an optimal way that maximize accuracy in locales and regions at the current epoch, maintain global self-consistency, and improve reliable forecasts. The system architecture underlying the linkage of models and data streams is modular, extensible, operationally reliable, and robust so as to serve as a platform for future commercial space weather needs.

### 2. INTRODUCTION

2.1 Identification of the Problem

2.1.1 Operational Challenges

The shorter-term variable impact of the Sun's photons, solar wind particles, and interplanetary magnetic field upon the Earth's environment that can adversely affect technological systems is colloquially known as space weather. It includes, for example, the effects of solar coronal mass ejections, solar flares and irradiances, solar and galactic energetic particles, as well as the solar wind, all of which affect Earth's magnetospheric particles and fields, geomagnetic and electrodynamical conditions, radiation belts, aurorae, ionosphere, and the neutral thermosphere and mesosphere during perturbed as well as quiet levels of solar activity.

The U.S. activity to understand, then mitigate, space weather risks is programmatically directed by the interagency National Space Weather Program (NSWP) and summarized in its NSWP Implementation Plan [2000]. That document describes a goal to improve our understanding of the physics underlying space weather and its effects upon terrestrial systems. A major step toward achievement of that goal will be demonstrated with the development of operational space weather systems which link models and data to provide a seamless energy-effect characterization from the Sun to the Earth.

In giving guidance to projects that are working towards operational space weather, the NSWP envisions the evolutionary definition, development, integration, validation, and transition-to-operations of empirical and physics-based models of the solar-terrestrial system. An end result of this process is the self-consistent, accurate specification and reliable forecast of space weather.

Particularly in relation to space weather's effects upon the ionosphere there are operational challenges resulting from electric field disturbances, irregularities, and scintillation. Space and ground operational systems affected by ionospheric space weather include telecommunications, Global Positioning System (GPS) navigation, and radar surveillance. As an example, solar coronal mass ejections produce highly variable, energetic particles embedded in the solar wind while large solar flares produce elevated fluxes of ultraviolet (UV) and extreme ultraviolet (EUV) photons. Both sources can be a major cause of terrestrial ionospheric perturbations at low- and high-latitudes. They drive the ionosphere to unstable states resulting in the occurrence of irregularities and rapid total electron content (TEC) changes.

High Frequency (HF) radio propagation, trans-ionospheric radio communications, and GPS navigation systems are particularly affected by these irregularities. For GPS users in perturbed ionospheric regions, the amplitude and phase scintillations of GPS signals can cause significant power fading in signals and phase errors leading to receivers' loss of signal tracking that translates directly into location inaccuracy and signal unavailability.

Ionospheric perturbed conditions can be recognized and specified in real-time or predicted through linkages of models and assimilated data streams. Linked systems must be based upon multi-spectral observations of the Sun, solar wind measurements by satellites between the Earth and Sun, as well as by measurements from radar and GPS/TEC networks. Models of the solar wind, solar irradiances, the neutral thermosphere, thermospheric winds, joule heating, particle precipitation, substorms, the electric field, and the ionosphere are able to provide climatological best-estimates of non-measured current and forecast parameters; the model results are improved by assimilated near real-time data.

This patent application describes a system that will detect and predict the conditions leading to dynamic ionospheric changes. The system will provide global-to-local specifications of recent history, current epoch, and up to 72-hour forecast ionospheric and neutral density profiles, TEC, plasma drifts, neutral winds, and temperatures. Geophysical changes will be captured and/or specified at their relevant time scales ranging from 10-minute to hourly cadences. 4-D ionospheric densities will be specified using data assimilation techniques that apply sophisticated optimization schemes with real-time ionospheric measurements and are coupled with physics-based and empirical models of thermospheric, solar, electric field, particle, and magnetic field parameters. This system maximizes accuracy in locales and regions at the current epoch, provides a global, up-to-the-minute specification of the ionosphere, and is globally self-consistent for reliable climatological forecasts with quantifiable uncertainties.

2.1.2 System Science Utility

While the main focus of our system is to provide operational ionospheric forecasts, we recognize that there will be considerable science value in the intermediate and final data products to be produced by this system. For example, the solved-for GAIM drivers contain useful scientific data for understanding storm effects. Also, the validation effort may reveal what physical range of input values are most important for driving model output, again leading to improved physical understanding.

In particular, the space physics science community has identified several interesting products organized by time and science discipline including: (1) the ensemble of space- and ground-based operational input data, (2) intermediate outputs from the 14 driver models associated with the operational input data, and (3) the ionospheric parameters output by the GAIM model.

We have established a collaborative partnership with the NSF-sponsored CISM organization at Boston University to provide that group's scientists with research access to archival data. During collaboration with the CISM community, we will establish Rules of the Road for archival data use. We plan to use our experience with the CISM community to make the archival data available to the broad science and engineering research communities.

Our team recognizes that the ionospheric parameter residuals from the physics-based data assimilation iterations contain information related to the quality of the current epoch nowcast. In addition, the forecast driver models are perturbed by the GAIM 4DVAR algorithm and those residuals provide a similar check on model fidelity. Areas in which there are large residuals point to potential research topics and we will make this information available to collaborative researchers outside our team for use in developing their own proposals to funding agencies.

Our team is producing peer-review journal articles on the system, its geophysical basis, and the results of its validation and verification exercises. These articles will help transfer operational knowledge that we obtain to the broad community.

### 3. METHODS AND ASSUMPTIONS

3.1 Transitioning Models to Operations

The prime objective in developing this operational ionospheric forecast system is to transition a diverse ensemble of space physics models and data streams into a seamless, coupled, linked system that robustly provides highly accurate nowcasts and physically-consistent, reliable climatological forecasts of ionospheric parameters to mitigate space weather effects. The system design has a high probability of success since most models and data streams we are using start at a relatively mature Technology Readiness Level (TRL) 6. Our work will take proven space physics models and data streams and will link them through state-of-the-art but very mature hardware/software architectural engineering. The system will robustly accommodate the widespread use of multiple-platform disseminated data streams, will build on ongoing independent model development at diverse institutions, and will provide information management for a wide variety of data types. Using a rapid-prototyping and development philosophy that combines the best available space physics models with operational data streams, we can accomplish our prime objective to mitigate space weather effects.

As a first step in the technical descriptions, we describe the geophysical basis, provide the definition of time domains used for organizing the information flow, and outline the model and data interconnections and dependencies. We then provide detailed explanations of the operational models and operational data we intend to incorporate into this system.

3.2 Geophysical Basis for the System

The software components of this operational ionospheric forecast system reflect the physics-based interconnections and the logical flow of geophysical processes in the Sun-Earth system. At the highest level, photospheric magnetograms and optical observations provide solar source surface and current sheet information for the solar wind model (HAF) forecasts. These combine with the ACE solar wind measurements and modeled ion drift velocities (DICM) resulting from high latitude electric field statistical convection patterns. This is complemented with background high latitude (B-driven HM87, W95) and equatorial (F10.7/E10.7-driven SF99) electric fields and (Dst/PC-driven) climatological particle precipitation (SwRI). Solar spectral irradiances (SOLAR2000) provide energy to the physics-based ionosphere (GAIM) and the same energy, binned as E10.7, drives the thermospheric mass densities (J70MOD) that are additionally perturbed by the geomagnetic a_{P}. These densities are used to scale the neutral species' densities (NRLMSIS00) while a physics-based thermospheric density model (1DTD) is used as an independent check on the scaled densities. The latter is driven by the same solar spectral irradiances used in J70MOD, NRLMSIS00, and GAIM; in addition, 1DTD is modulated by Joule heating (Knipp) which, in turn, is driven by the nowcast and forecast Dst (OM2000) that also drive the SwRI particle fluxes. Neutral winds (F10.7/E10.7-driven) (HWM93) are an added input to GAIM and this ensemble of data plus models provides best-estimate driving forces for the physics-based ionospheric forward model within GAIM.

GAIM algorithms improve the climatological estimates and produce highly accurate electron density profiles, global total electron content (TEC), and Chapman profile height and maxima of the F1, F2, and E layers, by using GPS-derived TEC and UV data sets that are assimilated through a Kalman filter. A second corrective algorithm, 4DVAR, uses the mapping of the modeled ionospheric state to the TEC and UV measurements in order to correct the output of the driving force models.

The top level outline of the geophysical basis for data objects and model linkages in the two concepts of operation (ConOps) is described in section 4.3.1 and includes the distributed network and the clustered turn-key/rack-mount systems. We will build the distributed network system at TRL 8 while the rack-mount system is a derivative of the distributed network and it will constitute the move from TRL 8 to TRL 9. We use the generic term “data object” in this patent application to encompass measurements, derived data, as well as forecast information.

In space weather characterization today, there is constant change. Therefore, in order to maximize advances in technology and physics or to take advantage of beneficial collaborations, we have modularly designed this system that links data objects and models. At the highest level, the operational system architecture has been designed so that the data communications superstructure is completely independent of any science model or data set. Linkage of the data I/O architecture to particular models and data occurs at lower levels using Unified Modeling Language (UML) protocols.

3.3 Time Domain Definition

A key element in achieving the prime objective of providing accurate nowcasts and reliable forecasts of ionospheric parameters is the organization of time into operationally useful domains. We define an operational time system that has a heritage in 3 decades of space weather characterization. Time domains are used to operationally designate the temporal interdependence of physical space weather parameters that are relative to the current moment in time, i.e., “now.” The current moment in time is the key time marker in the system and is called the current epoch in the aerospace community; we have adopted that usage here.

Relative to the current epoch, data contains information about the past, present, or future. In addition, data can be considered primary or secondary in an operational system that uses redundant data streams to mitigate risks. We separate past, present, or future state information contained within data by using the nomenclature of historical, nowcast, or forecast for primary data stream information which has been enhanced with time, spatial, or other resolution. We use previous, current, or predicted for secondary data stream information which has a climatological quality. Using these time domains, failures in the primary (enhanced) data stream result in the use of secondary data stream (climatological) values; the overall effect is to maintain operational continuity in exchange for increased uncertainty. This concept is also known as “graceful degradation.” Section 4.3.2.4 (Classes) provides a detailed description of the use of these time domains in the software and hardware system.

Historical or previous data are operationally defined as that information older than 24 hours prior to the current epoch. These data have usually been measured, processed, reported (issued), and distributed by the organization that creates the information. Their values are unlikely to change significantly and they are ready for transfer to permanent archives.

Nowcast or current data are operationally defined as that information for the most recent 24 hour period, i.e., 24 hours ago up to the current epoch. Some measured data have been received by an operational system but it is likely that not all inputs for all models are yet available. Modeled data are often produced using multiple data sources which can include the most recently received input data and estimated (recently forecast) data. Their values are likely to change and they are not ready for transfer to permanent archives.

Forecast or predicted data are operationally defined as that information in the future relative to the current epoch. Forecast data have not been measured but only modeled from either first principles or empirical algorithms. Their values are extremely likely to change and they are not ready for transfer to permanent archives.

Hence, the values for particular types of data can be in a state of constant change. For operational purposes, the data creation date is not related to its designation as historical/previous, nowcast/current, or forecast/predicted. Historical/previous data tend to be measured, static, and ready for archival, nowcast/current data tend to be either modeled or measured but transitional, and forecast/predicted data tend to be modeled and mutable.

The primary data stream contains historical, nowcast, and forecast time domains; data uncertainty increases through time in the forecast domain. The secondary data stream is identical with the exception that are the domain designations of previous, current, and predicted. Daily time granularity ranges from 48 hours in the past to 78 hours in the future and we use multiple time granularities over this time range. Time granularity is determined by model cadences combined with time information details.

The time domain design includes the −48 to −24 hour time range which allows for models' initialization, where necessary, with archival quality data. Nowcast is the −24 hours to the current epoch. The forecast range is extended beyond 3 days to +78 hours in order to guarantee a minimum 72-hour forecast. The operational time granularity includes 3-hour, 1-hour, and 15-minute data time steps with the real-time, highest time resolution centered on the current epoch ±1 hour.

3.4 Model and Data Dependencies

The space physics models used by the system and the input data that drive them or the output data they create, total 15 empirical or physics-based models and 25 data sets. Each has been selected for its operational or near-operational capability for use in this system. The models and data streams are at TRL 6 (unit demonstration in near-operational environment) and TRL 7 (system demonstration in a relevant operational environment) and the complete operational ionospheric forecast system can be demonstrated at TRL 8 (completed end-to-end system is tested, validated, and demonstrated in an operational environment).

Table 1 summarizes the model input/output (I/O) parameters and their run cadences in minutes; they are listed in their approximate run-order. Light gray listings are anticipated models or data sets. Table 2 lists the primary and secondary I/O parameters that are used to drive each of the models. Table 3 lists the user models, data input, producer models, data output, model creators, model host institutions, data creators, data host institutions, data stream IDs, as well as data and model TRL.

A key concept we use to guarantee operational robustness is that of “two streams” (see the risk management discussion in section 4.3.5). The primary stream is the enhanced system data and information flow path. This stream provides the high time resolution information and the local or regional detail of the ionosphere beyond climatology. It includes the GOES-N EUV, SSN DCA, all ground- and space-based TEC, C/NOFS VEFI and NWM, SSULI UV, ACE IMF B, and ground-observed solar surface magnetograms as well as electromagnetic observations. The secondary stream is the core information flow path and guarantees that the operational ionospheric forecast system produces a climatological forecast in the event of enhanced component failures or data outages. It includes F10.7, Mg II cwr, Ap (ap, Kp), Dst, PC, Pe, and Pp. The information flow within each stream starts from external space weather raw data, passes through model processing, and enters the database either as a final product or for use by downstream models.

3.5 Ionosphere Forecast Concept

The design of the ionospheric component of the forecast system, as distinct from the non-ionospheric space physics model drivers that provide input into GAIM, follows the mature and

TABLE 1
Model Inputs, Outputs, Cadences

| | | | | Cadence |
|---|---|---|---|---|
| Model | | | | max/min |
| (developer) | | Parameters Inputs Outputs | | minutes |
| 1. | S2K | F10.7 | I(λ₃₉, t) | 10/60 |
| | | Mg II cwr | E10.7 | |
| | | GOES-N* | | |
| 2. | HAF | photosphere | B(x, y, z, t) | 5/15 |
| | | magnetograms, | | |
| | | EM obs | V_{SW} | |
| | | | n_{SW} | |
| | | | p_{SW} | |
| 3. | Ap | Ap | ap | 15/60 |
| 4. | OM2000 | V_{SW} | Dst | 15/60 |
| 5. | HWM93 | A_{P} | U(θ, φ, z, t) | 30/60 |
| | | E10.7 | | |
| | | (F10.7) | | |
| 6. | HM87 | B(x, y, z, t) | w(θ, φ, z, t) | 15/30 |
| 7. | SF99 | E10.7 | w(θ, φ, z, t) | 15/30 |
| | | (F10.7) | | |
| 8. | W95 | B(x, y, z, t) | w(θ, φ, z, t) | 15/30 |
| 9. | Joule | Dst | Q_{J} | 5/15 |
| | heating | PC | | |
| 10. | SwRI particle | Dst | F(θ, φ, t) | 5/15 |
| | precipitation | Kp | | |
| | | PC | | |
| | | E10.7 | | |
| | | (F10.7) | | |
| 11. | DICM | B(y, z, t) | w(θ, φ, z, t) | 15/60 |
| 12. | J70MOD | E10.7 | ρ(θ, φ, z, t) | 15/60 |
| | | (F10.7) | | |
| | | A_{P} | | |
| | | DCA coefs | | |
| 13. | 1DTD | I(λ₃₉, t) | N(z, t) | 15/60 |
| | | A_{P} | ρ(z, t) | |
| | | Q_{J} | | |
| | | Q_{P} | | |
| 14. | NRLMSIS00 | E10.7 | N(θ, φ, z, t) | 30/60 |
| | | (F10.7) | ρ(θ, φ, z, t) | |
| | | A_{P} | | |
| 15. | GAIM | I(λ₃₉, t) | TEC(r_{R}, r_{S}, t) | 15/60 |
| | | E10.7, F10.7 | nₑ(θ, φ, z, t) | |
| | | A_{P} | | |
| | | N(θ, φ, z, t) | | |
| | | U(θ, φ, z, t) | | |
| | | w(θ, φ, z, t) | | |
| | | Pe, Pp | | |
| | | F(θ, φ, t) | | |
| | | Te, Ti | | |
| | | SSULI UV | | |
| | | TEC(r_{R}, r_{S}, t) | | |

*Light gray indicates future capability.

proven Concept of Operations (ConOps) of existing meteorological forecast systems such as ECMWF and NCEP. In general, the accuracy of the forecast is directly affected by the analysis of recent weather conditions that are used to initialize the forecast ionosphere model.

In the system ConOps, a balance between forecast ionosphere timeliness and accuracy leads to a design with an analysis schedule with multiple timescales. These are near real-time (NRT), hourly (1H), and 3-hour (3H) analyses. The main differences between these analyses are the quantity of ionospheric observations assimilated to produce them. The two key parameters affecting data availability are Data Collecting Window (DCW) and Cut-off Time (CT). For each analysis, data from a specified time interval is assimilated into the analysis model.

In order to produce analyses on schedule, a CT is specified for each analysis. The CT is the length of time after the DCW closes and before the start of analysis. The data collected in the DCW arriving after CT will not be used for a specific analysis but may be used for later analysis. For example, the hourly analysis for 0600 UT may have a 3-hour DCW starting at 0330 UT. If the CT is one-half hour for the 1H analysis, then data collected in the DCW for the 0600 UT analysis must arrive before 0700 UT. An analysis result becomes available after the completion of data assimilation which requires a Run-Time (RT) of specific length. In general, the RT is directly proportional to the length of DCW. The latency of the analysis is the length of time after the analysis epoch when the analysis result becomes available. In Table 4, we give an overview of an analyses schedule relative to the current epoch time, t₀.

To ensure that all analyses benefit from high-quality 3H analysis, the data assimilation model is initialized using the previous analyses. In addition to schedule differences, the contents of analyses are also different. The adjustment of the ionospheric driver requires long-term data and is computationally complex. Therefore, the NRT analysis does not update some of ionospheric drivers.

Near real-time (hours) ionosphere forecast production is similar to extrapolating a curve that is slightly perturbed by errors. The quality of long-range extrapolation requires accurate estimation of the curve trend. In the case of forecast, the quality of analysis is affected by both the length of the DCW and latency; the quality of the forecast is related to the quality of the analysis. Longer DCWs produce better analyses and latency does not seem to directly affect

TABLE 2
Primary, Secondary I/O Parameters

| Parameter | I/O | Data Source | User Model; mode* |
|---|---|---|---|
| Ap | I | NOAA SEC | HWM93, J70MOD, 1DTD, |
| | | | GAIM, MSIS: H, N, F |
| | O | McPherron | |
| B(x, y, z, t) | I | ACE | DICM, HM87, W95; |
| | | | H, N, F |
| | O | HAF | |
| OCA coefs | I | SSN | J70MOD; N, F |
| Dst | O | WDC-C2 | SwRI, Joule heating; |
| | | | H, N, F |
| | I | OM2000 | |
| E10.7 | O | S2K | SwRI, HWM93, J70MOD, |
| | | | GAIM, MSIS, SF99; |
| | | | H, N, F |
| | I | | |
| EM obs | I | NOAA SEC | HAF; N, F |
| F(θ, φ, t) | O | SwRI | GAIM; H, N, F |
| | I | | |
| F10.7 | I | NOAA SEC | S2K, SwRI, HWM93, |
| | | SET | J70MOD, GAIM, MSIS, |
| | | | SF99; H, N, F |
| GOES-N | I | NOAA SEC | S2K; N, F |
| I(λ₃₉, t) | O/I | S2K | 1DTD, GAIM; H, N, F |
| Kp | I | NOAA SEC | SwRI; H, N, F |
| Mg II cwr | I | NOAA SEC | S2K; H, N, F |
| | | SET | |
| N(θ, φ, z, t) | O/I | (1DTD) | GAIM; H, N, F |
| | | MSIS | |
| nₑ(θ, φ, z, t) | O | GAIM | users; H, N, F |
| PC | I | WDC-C2 | SwRI, Joule heating; |
| | | | H |
| magnetogram | I | NOAA SEC | HAF; N, F |
| Pe, Pp, Q_{P} | I | NOAA SEC | GAIM, 1DTD; H, N |
| φ | I/O | geometry - | DICM, GAIM, SwRI, |
| | | mag long, | HWM93, J70MOD, MSIS, |
| | | local time | SF99, W95, HM87; |
| | | | H, N, F |
| Q_{J} | O/I | Knipp | 1DTD; H, N, F |
| ρ(θ, φ, z, t) | O | J70MOD | (1DTD, MSIS); H, |
| | | | N, F |
| SSULI UV | I | DMSP | GAIM; H, N |
| t | I/O | UT clock - | all models, data |
| | | Time | sets, parameters; |
| | | | H, N, F |
| Te | O | GAIM | GAIM; H, N, F |
| TEC(r_{R}, r_{S}, t) | I/O | JPL GPS, CORS, | GAIM; H, N, F |
| | | C/N CORISS | |
| Ti | O | GAIM | GAIM; H, N, F |
| θ | I/O | geometry - | DICM, GAIM, SwRI, |
| | | magnetic | HWM93, J70MOD, MSIS, |
| | | latitude | SF99, W95, HM87; |
| | | | H, N, F |
| U(θ, φ, z, t) | O/I | HWM93 | GAIM; H, N, F |
| | | C/N NWM | |
| V_{SW} | O/I | ACE, HAF | OM2000; H, N, F |
| w(θ, φ, z, t) | O/I | DICM, C/N VEFI, | GAIM; H, N, F |
| | | SF99, W95, HM87 | |
| z | O | geometry - | DICM, HWM93, J70MOD, |
| | | altitude | 1DTD, GAIM, MSIS, |
| | | | SF99, W95, HM87, |
| | | | SwRI; H, N, F |

*H = historical; N = nowcast; F = forecast; light gray indicates future capability.

TABLE 3
Model and Data Characteristics

| User | | Producer | Data | Model | Model | Data | Data | | Data | Model |
|---|---|---|---|---|---|---|---|---|---|---|
| Model | Data input | Model | output | Mfg | Host | Mfg | Host | Stream | TRL | TRL |
| S2K | F10.7 | | | SET | SET | Penticton | NOAA | B | 9 | 9 |
| S2K | Mg II cwr | | | SET | SET | NOAA | NOAA | B | 9 | 9 |
| S2K | GOES-N* | | | SET | SET | NOAA | NOAA | A | 3 | 9 |
| | | S2K | I(λ₃₉, t) | SET | SET | SET | SET | A | 6 | 9 |
| | | S2K | E10.7 | SET | SET | SET | SET | A | 9 | 9 |
| HAF | magnetogram | | | EXPI | EXPI | NSO | NSO | A | 9 | 6 |
| HAF | EM obs | | | EXPI | EXPI | NSO | NSO | A | 9 | 6 |
| | | HAF | B(x, y, z, t) | EXPI | EXPI | EXPI | EXPI | A | 6 | 6 |
| | | HAF | V_{SW} | EXPI | EXPI | EXPI | EXPI | A | 6 | 6 |
| | | HAF | n_{SW} | EXPI | EXPI | EXPI | EXPI | A | 6 | 6 |
| | | HAF | p_{SW} | EXPI | EXPI | EXPI | EXPI | A | 6 | 6 |
| SwRI | Dst | | | SwRI | SwRI | Kyoto | WDC | B | 9 | 6 |
| SwRI | Dst | | | SwRI | SwRI | UCLA | SET | A | 6 | 6 |
| SwRI | E10.7 | | | SwRI | SwRI | SET | SET | A | 9 | 6 |
| SwRI | (F10.7) | | | SwRI | SwRI | Penticton | NOAA | B | 9 | 6 |
| SwRI | Kp | | | SwRI | SwRI | USAF | NOAA | B | 9 | 6 |
| SwRI | PC | | | SwRI | SwRI | DMI | WDC | B | 4 | 6 |
| | | SwRI | F(θ, φ, t) | SwRI | SwRI | SwRI | SwRI | A | 6 | 6 |
| DICM | B(x, y, z, t) | | | GS | SET | ACE | NOAA | A | 9 | 6 |
| DICM | B(x, y, z, t) | | | GS | SET | EXPI | EXPI | A | 6 | 6 |
| | | DICM | w(θ, φ, z, t) | GS | SET | GS | SET | A | 6 | 6 |
| Joule heat | Dst | | | USAFA | SET | Kyoto | WDC | B | 9 | 5 |
| Joule heat | Dst | | | USAFA | SET | UCLA | SET | A | 6 | 5 |
| Joule heat | PC | | | USAFA | SET | DMI | WDC | B | 4 | 5 |
| | | Joule heat | Q_{J} | USAFA | SET | USAFA | SET | A | 5 | 5 |
| HWM93 | A_{P} | | | Hedin | SET | USAF | NOAA | B | 9 | 6 |
| HWM93 | A_{P} | | | Hedin | SET | UCLA | SET | A | 6 | 6 |
| HWM93 | E10.7 | | | Hedin | SET | SET | SET | A | 9 | 6 |
| HWM93 | (F10.7) | | | Hedin | SET | Penticton | NOAA | B | 9 | 6 |
| | | HWM93 | U(θ, φ, z, t) | Hedin | SET | CU | SET | A | 5 | 6 |
| | | HWM93 | U(θ, φ, z, t) | Hedin | SET | CU | USC | B | 6 | 6 |
| J70MOD | E10.7 | | | ASAC | SET | SET | SET | A | 9 | 8 |
| J70MOD | F10.7 | | | ASAC | SET | Penticton | NOAA | B | 9 | 8 |
| J70MOD | A_{P} | | | ASAC | SET | USAF | NOAA | B | 9 | 8 |
| J70MOD | A_{P} | | | ASAC | SET | UCLA | SET | A | 6 | 8 |
| J70MOD | DCA | | | ASAC | SET | ASAC | ASAC | A | 3 | 8 |
| | | J70MOD | ρ(θ, φ, z, t) | ASAC | SET | ASAC | SET | A | 6 | 8 |
| 1DTD | I(λ₃₉, t) | | | SET | SET | SET | SET | A | 8 | 5 |
| 1DTD | A_{P} | | | SET | SET | USAF | NOAA | B | 9 | 5 |
| 1DTD | A_{P} | | | SET | SET | UCLA | SET | A | 6 | 5 |
| 1DTD | Q_{J} | | | SET | SET | USAFA | SET | A | 5 | 5 |
| 1DTD | Q_{P} | | | SET | SET | POES | NOAA | B | 8 | 5 |
| | | 1DTD | N(z, t) | SET | SET | SET | SET | A | 5 | 5 |
| | | 1DTD | ρ(z, t) | SET | SET | SET | SET | A | 5 | 5 |
| NRLMSIS | E10.7 | | | NRL | SET | SET | SET | A | 9 | 6 |
| NRLMSIS | (F10.7) | | | NRL | SET | Penticton | NOAA | B | 9 | 6 |
| NRLMSIS | A_{P} | | | NRL | SET | USAF | NOAA | B | 9 | 6 |
| NRLMSIS | A_{P} | | | NRL | SET | UCLA | SET | A | 6 | 6 |
| | | NRLMSIS | N(θ, φ, z, t) | NRL | SET | SET | SET | A | 5 | 6 |
| | | NRLMSIS | N(θ, φ, z, t) | NRL | USC | USC | USC | B | 6 | 6 |
| | | NRLMSIS | ρ(θ, φ, z, t) | NRL | SET | SET | SET | A | 5 | 6 |
| McPherron | A_{P} | | | UCLA | SET | USAF | NOAA | B | 9 | 6 |
| | | McPherron | A_{P} | UCLA | SET | UCLA | SET | A | 6 | 6 |
| OM2000 | V_{SW} | | | UCLA | SET | ACE | NOAA | A | 9 | 5 |
| OM2000 | V_{SW} | | | UCLA | SET | EXPI | EXPI | A | 6 | 5 |
| | | OM2000 | Dst | UCLA | SET | UCLA | SET | A | 5 | 5 |
| HM87 | B(x, y, z, t) | | | HM | USC | ACE | NOAA | A | 9 | 6 |
| HM87 | B(x, y, z, t) | | | HM | USC | EXPI | EXPI | A | 6 | 6 |
| | | HM87 | w(θ, φ, z, t) | HM | USC | USC | USC | A | 6 | 6 |
| W95 | B(x, y, z, t) | | | Weimer | USC | ACE | NOAA | A | 9 | 6 |
| W95 | B(x, y, z, t) | | | Weimer | USC | EXPI | EXPI | A | 6 | 6 |
| | | W95 | w(θ, φ, z, t) | Weimer | USC | USC | USC | A | 6 | 6 |
| SF99 | E10.7 | | | SF | USC | SET | SET | A | 9 | 6 |
| SF99 | (F10.7) | | | SF | USC | Penticton | NOAA | B | 9 | 6 |
| | | SF99 | w(θ, φ, z, t) | SF | USC | USC | USC | B | 6 | 6 |
| GAIM | I(λ₃₉, t) | | | USC | JPL | SET | SET | A | 6 | 6 |
| GAIM | E10.7 | | | USC | JPL | SET | SET | A | 9 | 6 |
| GAIM | (F10.7) | | | USC | JPL | Penticton | NOAA | B | 9 | 6 |
| GAIM | A_{P} | | | USC | JPL | USAF | NOAA | B | 9 | 6 |
| GAIM | A_{P} | | | USC | JPL | UCLA | SET | A | 6 | 6 |
| GAIM | N(θ, φ, z, t) | | | USC | JPL | SET | SET | A | 5 | 6 |
| GAIM | N(θ, φ, z, t) | | | USC | JPL | USC | USC | B | 6 | 6 |
| GAIM | U(θ, φ, z, t) | | | USC | JPL | CU | SET | A | 5 | 6 |
| GAIM | U(θ, φ, z, t) | | | USC | JPL | CU | USC | B | 6 | 6 |
| GAIM | U(θ, φ, z, t) | | | USC | JPL | NWM | C/NOFS | A | 3 | 6 |
| GAIM | w(θ, φ, z, t) | | | USC | JPL | GS | SET | A | 6 | 6 |
| GAIM | w(θ, φ, z, t) | | | USC | JPL | USC | USC | A | 6 | 6 |
| GAIM | w(θ, φ, z, t) | | | USC | JPL | USC | USC | A | 6 | 6 |
| GAIM | w(θ, φ, z, t) | | | USC | JPL | USC | USC | B | 6 | 6 |
| GAIM | w(θ, φ, z, t) | | | USC | JPL | VERI | C/NOFS | A | 3 | 6 |
| GAIM | Pe, Pp | | | USC | JPL | NOAA | NOAA | B | 9 | 6 |
| GAIM | F(θ, φ, t) | | | USC | JPL | SwRI | SwRI | A | 6 | 6 |
| GAIM | Ti | | | USC | JPL | USC | USC | B | 6 | 6 |
| GAIM | Te | | | USC | JPL | USC | USC | B | 6 | 6 |
| GAIM | SSULI UV | | | USC | JPL | DMSP | SSULI | A | 7 | 6 |
| GAIM | TEC(r_{R}, r_{S}, t) | | | USC | JPL | JPL | JPL | A | 9 | 6 |
| GAIM | TEC(r_{R}, r_{S}, t) | | | USC | JPL | CORISS | C/NOFS | A | 3 | 6 |
| GAIM | TEC(r_{R}, r_{S}, t) | | | USC | JPL | USC | COSMIC | A | 3 | 6 |
| GAIM | TEC(r_{R}, r_{S}, t) | | | USC | JPL | CORS | NOAA | A | 8 | 6 |
| | | GAIM | TEC(r_{R}, r_{S}, t) | USC | JPL | USC | USC | A | 6 | 6 |
| | | GAIM | nₑ(θ, φ, z, t) | USC | JPL | USC | USC | A | 6 | 6 |

*Light gray indicates future capability.

TABLE 4
Ionosphere Forecast Analysis Schedule

| Analysis | | CT | RT | Latency |
|---|---|---|---|---|
| Schedule | DCW (Hour) | (Hour) | (Hour) | (hour) |
| NRT | [t₀ − 25, t₀] | ⅙ | 1/12 | 0.25 |
| 1H | [t₀ − 2.5, t₀ + 0.5] | 0.5 | 0.5 | 1.5 |
| 3H | [t₀ − 5, t₀ + 1] | 1 | 1 | 3 |

forecast accuracy. Beyond a few hours, the climatological driver models' inputs provide the forecast up to 72 hours.

Since the computational resources required for forecast are considerably smaller than for data assimilation, this design includes the possibility of producing a forecast based on different analysis results. For example, for a high-time resolution forecast, the state of the ionosphere is computed every 15 minutes from the current epoch to 3 hours into the future based on the most recent NRT, 1H and 3H analyses, respectively. The difference in the forecasts can be used for uncertainty analysis. This approach is similar to ensemble forecasting which is widely used by the meteorological community. The basic integration interval for models like GAIM is limited by the underlying physics. As a result, if a 72-hour forecast is computed, the state of the ionosphere is reported every 15 minutes up to every hour.

The system design includes a variable reporting interval. In general, the transient effect from the assimilation of recent data is dissipated in time and the forecast gradually returns to climatological values. As the forecast moves further away from the current epoch, a high frequency of forecast reporting is not necessary, i.e., the time granularity becomes coarser.

In addition to temporal granularity, the spatial resolution of the forecast is dependent on the size of the region covered by the model. The basic design includes a global forecast region and several high resolution regional forecast domains. The global forecast is updated hourly. The first 6 hours of the forecast is reported at 15 minute intervals, and 6 hours into the forecast, the reporting interval increases to 1 hour. The regional forecast domain can have a forecast updated as frequently as every 15 minutes. The specific definition of regional domains is to be defined but would certainly include CONUS, Europe, and a few other high interest regions. Options exist to provide the capability of easily defining new regions based upon changing interests.

### 4. RESULTS AND DISCUSSION

We start the detailed discussion of each model using a summary table. In Table 5 we list each model by its science discipline area, relevant web site link where applicable, and upgrade plan through ongoing, separately funded work. We recognize that space physics models are in a state of continual change and we see it as a strength of this system that we can modularly incorporate changes to the models that have been upgraded independently. The architecture uses version control, independent platform development, and test platform validation and verification before a model is released to the operational environment (section 4.3.4 Upgrades, Maintenance Strategy).

4.1 Operational Models

4.1.1 Ionospheric Parameters

4.1.1.1 GAIM

4.1.1.1.1 Model Description:

The Global Assimilative Ionospheric Model (GAIM) (Pi et al., 2001) provides a reliable and accurate global ionospheric weather monitoring, nowcast and forecast specification. The

TABLE 5
Models' Disciplines, Weblinks, and Expected Upgrades

| Model | Discipline | Weblink | Expected Upgrades |
|---|---|---|---|
| S2K | Solar irradiance | http://SpaceWx.com | GOES-N, SXI inclusion |
| HAF | Solar wind | http://www.expi.com/expinet/kinematic.html | ongoing |
| Ap | High latitude heating | | ongoing |
| OM2000 | High latitude heating | http://www.igpp.ucla.edu/public/tpoiii/rt_dst/ | ongoing |
| HWM93 | Thermospheric wind | | possible |
| HM87 | Plasma drift | | none |
| SF99 | Plasma drift | | none |
| W95 | Plasma drift | | W03 (?) |
| Joule heat | High latitude heating | | ongoing |
| SwR1 | Particle precipitation | http://climatology.space.swri.edu/ | NOAA-15, -16 inclusion and |
| | | | Dst main phase, recovery fit |
| DICM | Plasma drift | http://maggy.engin.umich.edu/mist/limie.html | ongoing |
| J70MOD | Thermospheric density | | DCA coefs to be operational |
| 1DTD | Thermospheric density | | ongoing |
| NRLMSIS | Thermospheric density | | ongoing |
| GAIM | Ionosphere | http://iono.jpl.nasa.gov/gaim | ongoing |

short-term forecast is accomplished using state-of-the-art ionospheric data assimilation techniques combined with inputs from driver models for modeled space weather and a physics-based ionospheric model. The data assimilation techniques include the 4-dimensional variational (4DVAR) and the recursive Kalman filter techniques which enable GAIM to conduct two major tasks. First, using 4DVAR, GAIM estimates the driver models' weather behavior that satisfy the requirements of minimizing differences between observations such as line-of-sight TEC on regional or global scales and predicted observations based on the ionospheric model state (Pi et al., 2003). The corrected driver models' outputs are then used to drive the ionospheric model forward in time to generate forecasts for the next few hours. Second, given the 4DVAR-corrected driver model estimates, the Kalman filter will further adjust the ionospheric forward model state by weighting the 4DVAR-corrected model results and the apriori forecast of the state (Hajj et al., 2003; Wang et al., 2003). The resulting ionosphere is highly accurate.

The medium-term forecast incorporates 72-hour solar, electrodynamical, and thermospheric inputs. GAIM can use any theoretical, empirical, or assimilative model that specifies input drivers such as solar EUV spectral irradiance I(λ₃₉,t), E×B drifts, particle precipitation F(θ,φ,t), thermospheric densities n(θ,φ,z,t), and neutral winds U(θ,φ,z,t). These are inputs to the discretized collisional hydrodynamic equations of GAIM and the latter solves 4-D (space, time) ion and electron densities either globally or regionally. The model's regional, temporal, and spatial resolutions are easily specified. GAIM is comprised of several modules: (1) the forward model based on first-principles physics, (2) an observation processor and operator, (3) optimization processors, and (4) post-processing and visual-analysis tools.

4.1.1.1.2 Model Inputs:

GAIM's forward model includes empirical driver models:
1. I(λ₃₉,t): EUV solar irradiances (EUV94 and SOLAR2000 39 wavelength group photon flux);
2. N(θ,φ,z,t): neutral densities O, O₂, N₂, N, H, He, temperature (format of MSIS90 and/or NRLMSIS00 but corrected by J70MOD mass densities and compared with 1DTD neutral densities);
3. U(θ,φ,z,t): horizontal winds (HWM93);
4. w(θ,φ,z,t): plasma drift velocities from E×B drift model for low latitudes (Scherliess and Fejer, 1999, SF99) and E×B convection models (Wiemer 1995, W95);
5. w(θ,φ,z,t): plasma drift velocities from E×B convection models for high latitudes (DICM; Heppner and Maynard 1987, HM87);
6. F(θ,φ,z,t): particle precipitation empirical patterns (SwRI model using NOAA climatology);
7. Q_{P}: NOAA hemispheric power level (POES); and
8. Tₑ, Tᵢ: empirical model for electron and ion temperatures.

Various data types can be input including ground- and space-based GPS TEC measurements, UV radiances, in-situ electron and ion densities, and ionosondes. A thorough discussion of the data input into GAIM is given in section 4.2.

4.1.1.1.3 Model Outputs:

Line-of-sight TEC(r_{R},r_{S},t), electron density, nₑ(θ,φ,z,t), f₁₀₀F₂, and hₘF₂ globally and regionally are outputs of GAIM. There are 6-hour short-term forecasts and 72-hour medium term-forecasts. Hourly updates of global and regional ionospheric states will be generated.

The forecast concept for GAIM starts with the current epoch at “0” using an hourly database update of GAIM ionospheric output for a +72-hour and −48-hour time range. Once per day (start at 0 UT) there will be a daily global archive on a 5°×5° latitude/longitude grid with look-back optimization to 48 hours into the past. Then, during each hour of the remaining 23 hours, there will be a first half-hour segment of global forecast to 72-hours (5°×5°) with a 6-hour look-back optimization. There will always be a 72-hour forecast. Next, in the second half-hour segment, a set of regional forecasts to 6 hours (<5×5°) with a 1-hour look-back optimization will be run.

GAIM will use, as its input, the output from each of the other models at their own geophysical cadence. GAIM outputs for the global archive are written for each 3-hour time segment; for the hourly global run there will be ionospheric output every 1-hour time segment. For the regional hourly run, there will be output every 15 minutes the first hour then hourly out to 6 hours. Output data overlaid (inserted) into the database time slots will be the update method.

There are several options to reduce compute time and they include:

1. add processors;

2. rotate regions (every 2-3 hours);

3. change latitude/longitude bin size;

4. change definition of region size;

5. limit the number of regions; and

6. change the number of look-back hours for optimization.

A distributed network system will demonstrate a subset of these options; extensibility and scalability will be options for a TRL 9 operational system.

4.1.2 Solar Wind

4.1.2.1 HAF

4.1.2.1.1 Model Description:

The Hakamada-Akasofu-Fry (HAF) Solar Wind Model was developed by the Geophysical Institute, University of Alaska, Fairbanks (GI/UAF) and Exploration Physics International, Inc. (EXPI). The HAF model provides quantitative forecasts, days in advance, of solar wind conditions. Specifically, it tracks interplanetary disturbances as they propagate from their source at the Sun. HAF also provides temporal profiles of the solar wind speed, density, dynamic pressure, and Interplanetary Magnetic Field (IMF) anywhere in the solar system.

The HAF model is driven using synoptic solar observations and solar event reports. This information is used to predict the timing and severity of space weather disturbances following solar events or the passage of Co-rotating Interaction Regions (CIR). The HAF model maps the disturbed and the undisturbed solar wind so it is applicable to all phases of the solar cycle. Additionally, HAF produces chronological sequences of ecliptic-plane plots of the IMF and other solar wind parameters.

The HAF kinematic procedure follows fluid parcels and the frozen-in IMF field lines. This approach to first principles conserves mass and momentum but not energy. This methodology is described by Hakamada and Akasofu (1982), Fry (1985), Akasofu (2001) and Fry et al. (2001, 2003). The HAF model internal parameters have been calibrated with a 1-D MHD model (Sun et al., 1985; Dryer, 1994). Recent model improvements are described in Fry et al. (2001) and validation of the model is discussed in Fry et al. (2003). Eventually, HAF would form part of, or even be replaced by, a hybrid system that includes the HAF model and a first principles 3D MHD model as envisioned by Dryer (1994, 1998) and Detman (private communication, 2002).

4.1.2.1.2 Model Inputs:

Ambient Solar Wind (vector magnetograms) and Event-Driven Solar Wind (EM observations) are the two primary model inputs.

Ambient Solar Wind: Input for the “non-event” background solar wind is provided by solar surface magnetograms (vector magnetograms) from the National Solar observatory, Tucson, Ariz. that are utilized to construct a potential field coronal magnetic field model. This model is then used to build a map of the radial IMF and velocity (Wang and Sheeley, 1990; Arge and Pizzo, 2000) at a spherical “source surface” at 2.5 R_{S} (where R_{S} is the solar radius and is equal to 6.9×10⁶ km). These inner boundary conditions are then used to initialize the kinematic HAF code. The output of the HAF model has been extended to beyond 10 AU, but generally is routinely confined to 2 AU for inner heliospheric prediction purposes.

The background solar wind plasma and IMF are established as follows. The HAF model is run and the results are calculations of the solar wind conditions from the Sun to the Earth and beyond. These results provide a simulation of fast and slow solar wind streams together with both inward and outward IMF polarity in the ecliptic plane. This non-uniform background includes co-rotating coronal hole flow interactions as well as the deformed heliospheric current sheet. It is updated whenever new source surface maps become available, currently daily. This procedure simulates the varying flow of the “non-event” plasma and IMF past the Earth and the other planets. The passage of large magnitude, southerly-directed IMF structures (approximately B_{z}=10 nT for about 3 or more hours) under such conditions can be geoeffective and generate geomagnetic activity.

Event-Driven Solar Wind: Solar events, such as flares, eruptive prominences, and destabilized helmet streamers, provide information necessary to characterize the disturbed solar wind by modifying the ambient solar wind conditions. Primary event inputs are based upon solar flare and the metric type-II radio emission observations. In the HAF forecast system a solar event is characterized by simultaneous (within an hour) optical, X-ray, and metric type-II radio observations. Optical observations of the flare provide the location on the solar disk of the source of the “event” energy. The duration of the flare's soft X-ray output serves as a proxy for the shock's piston-driving time. The metric type-II radio burst observation, coupled with a coronal density model, provides an estimate of the initial coronal shock speed, Vs, the magnitude of which is assumed to be related to the solar disturbance's energy output. These optical, radio, and X-ray observations (EM observations) are provided on a real-time basis by the U.S. Air Force Weather Agency and the NOAA Space Environment Center. Table 6 lists the HAF model inputs and associated data sources.

4.1.2.1.3 Model Outputs:

The model produces IMF B(x,y,z,t), Temporal Profiles of Solar Wind Parameters, Ecliptic/Equatorial Plane Displays, and Shock Arrival Time.

Temporal Profiles of Solar Wind Parameters: HAF predicts values of specific physical parameters, such as plasma velocity, V, IMF magnitude and polarity (B and, in particular, B_{z}), density, n, and dynamic pressure, p, at one-hour time steps extending 5-27 days into the future.

Ecliptic/Equatorial Plane Displays: The forecaster can examine an ecliptic plane figure provided by HAF that shows the co-rotating flow and IMF during the “pre-event” specification of plasma and IMF background. Following the “event,” the forecaster can examine the temporal and spatial evolution of the propagating Interplanetary Coronal Mass Ejection (ICME) together with its shock. Displays include the predicted IMF configuration and the location of Earth (specifically at the L1 spacecraft location) in the ecliptic plane and of Mars (for calibration and research purposes) at 12-hour intervals for 5 days into the future.

Shock Arrival Time: The predicted Shock Arrival Time (SAT) is determined by computing a Shock Searching Index (SSI). The SSI is equal to the logarithm (base 10) of the model's dynamic pressure change, normalized to the pre-disturbed dynamic pressure, at each time step. The event's shock arrival time is predicted when this SSI reaches an empirically determined threshold value (currently SSI=−0.35). If this SSI threshold is not achieved, the shock is declared to have decayed to an MHD wave by the time the disturbance reaches the Earth's location. By comparing HAF model results with ACE and/or SOHO observations, the prediction error is then the time difference, i.e., the prediction time minus the observed SAT. Predicted

TABLE 6
Data Sources for HAF Solar Wind Model

| | Data Source/ | Instrument/ | | | Desired | |
|---|---|---|---|---|---|---|
| Input Parameter | Observation | Observatory | OPR | When Updated | Resolution | Status* |
| Simulation start time | Forecaster or auto | — | Forecaster | Scheduled | 15 minutes | 1 |
| | | | | or event | | |
| Ambient solar wind: | | | | | | |
| a. Inner boundary | Photospheric | WSO, MWO, | NOAA | Automatic, once | 5° × 5° (HAF v2); | 1 |
| magnetic field grid | magnetic field | NSO ISOON | SEC | or twice-daily | 1° × 1° (HAF v3) | 1 |
| | | | RPC | | | |
| b. Inner boundary | Empirical | Derived from 2a | UAF/GI | Same as 2a | Same as 2a | 1 |
| velocity grid | algorithm | | | | | |
| c. Inner boundary | Empirical | Derived from 2a | UAF/GI | Same as 2a | Same as 2a | 1 |
| density grid | algorithm | | | | | |
| Events: | | | | | | |
| a. Time event began | X-ray flux, Type II | GOES X-ray, | NOAA | Receipt of report | 5 minutes | 1, 2 |
| | threshold | SXI | SEC | | | |
| b. Time event maximum | X-ray flux peak | GOES X-ray, | NOAA | Receipt of report | 5 minutes | 1, 2 |
| | | SXI | SEC | | | |
| c. Time event end | X-ray flux drops to | GOES X-ray, | NOAA | Receipt of report | 5 minutes | 1, 2 |
| | ½ max on log plot | SXI | SEC | | | |
| d. Heliolatitude of | Hα flare location; | SOON; GOES | USAF | Receipt of report | 5° (HAF v2) | 1 |
| event source location | X-ray, radio source | SXI | | | 1° (HAF v3) | 1, 2 |
| | location | | | | | |
| e. Heliolongitude of | Hα flare location; | SOON; GOES | USAF | Receipt of report | 5° (HAF v2) | 1 |
| event source location | X-ray, radio source | SXI | | | 1° (HAF v3) | 1, 2 |
| | location | | | | | |
| f. Initial shock speed | Type II Shock Speed | SOON, SFIR; | USAF | Receipt of report | 50 km/sec | 1 |
| | | SRS | | | | |
| g. Shock shape | Shock angular width | From 3a, b, c, for | UAF/GI | At report time | 10 degrees | 1/3 |
| parameter | | free parameter | | | | |

*Status: 1 = Presently operational; 2 = Scheduled; 3 = Required but not planned

shock arrival time, when compared with ACE spacecraft observations, provides a metric for evaluating model performance and demonstrates the “goodness” of solar wind parameter temporal profiles modeled by HAF. The model RMS error is presently about ±12 hours. We note that the inclusion of real-time ACE data substantially improves the actual shock arrival time estimation.
4.1.3 Plasma Drifts
4.1.3.1 DICM
4.1.3.1.1 Model Description:

The DMSP-based Ionospheric Convection Model (DICM) (Papitashvili et al., 1994, 1998, 1999, 2002) uses the ionospheric electrostatic potentials for its construction which have been inferred from the cross-track thermal ion drift velocity measurements made onboard of the DMSP satellites F8 and F10-F13 in 1993-1996. These satellite measurements and the simultaneous observations of the Solar Wind (SW) and Interplanetary Magnetic Field (IMF) conditions near the Earth's orbit have been correlated to create an empirical model of the high-latitude electric potential patterns for various IMF/SW conditions. As a result, DICM is fully parameterized by the IMF strength and directions and constructed for different seasons (summer, equinox, and winter). Running this model, ionospheric convection patterns are generated for any given IMF configuration for quiet-to-moderate geomagnetic activity conditions. New elements in DICM are its “quasi-viscous” patterns for IMF 0 and separate, IMF-dependent patterns constructed for both northern and southern polar regions which are not available in other ionospheric convection models.

4.1.3.1.2 Model Inputs:

The model uses B(y,z,t) and time as inputs. Control parameters include the transverse orientation of the interplanetary magnetic field By, Bz (in GSM coordinates), and the orientation of the Earth's magnetic axis (season) at the time of interest. These parameters are used to set up the model for the desired conditions. Time is input in ISO standard format of YYYY-MM-DD hh:mm:ss.fff.

4.1.3.1.3 Model Outputs:

The output from the model is the plasma drift velocity, w(θ,φ,z,t), in the form of ionospheric electrostatic potential maps, in kilovolts (kV), constructed either as a function of the corrected geomagnetic (CGM) latitude and magnetic local time (MLT), or in geographic coordinates for given universal time (UT). The output file is flat ASCII, approximately 8 kB for each time step, in latitude (y-axis) and MLT x-axis).

4.1.3.2 W95

4.1.3.2.1 Model Description:

The E×B convection models for high latitudes (Weimer, 1995; Weimer et al., 2003) is embedded within the GAIM model.

4.1.3.2.2 Model Inputs:

IMF B(t) is the input.

4.1.3.2.3 Model Outputs:

w(θ,φ,z,t) is the output for high latitudes.

4.1.3.3 HM87

4.1.3.3.1 Model Description:

The E×B convection model for high latitudes (Heppner and Maynard, 1987) uses IMF B and is included as a background model within GAIM.

4.1.3.3.2 Model Inputs:

IMF B from ACE or HAF is the input.

4.1.3.3.3 Model Outputs:

w(θ,φ,z,t) is the output.

4.1.3.4 SF99

4.1.3.4.1 Model Description:

The equatorial E×B drift model by Scherliess and Fejer (1999) (SF99) is used internal to GAIM.

4.1.3.4.2 Model Inputs:

E10.7 (primary stream) and F10.7 (secondary stream) are the inputs.

4.1.3.4.3 Model Outputs:

w(θ,φ,z,t) is the output for low latitudes.

4.1.4 Particle Precipitation

4.1.4.1 SwRI Particle Precipitation

4.1.4.1.1 Model Description:

Climatological particle precipitation is described in an abstract for the SwRI model by Wüest et al., 2002 and Wüest et al., 2003. These papers are available on the SwRI climatology web site until they appear in print, i.e., http://climatology.space.swri.edu.

Electron energy deposition in the atmosphere is important in that it drives ionospheric convection and ion chemistry in the upper atmosphere. Further, electron precipitation can contribute to spacecraft charging and can cause disruption of high-frequency communication between airplanes and ground stations, particularly affecting transpolar flights. The model of electron precipitation to be used in this system is the SwRI NOAA-12 Climatology model. In GAIM, the particle flux climatology will be an external driver of the global atmospheric system.

The climatology is provided by an empirical statistical model of average incident electron flux and differential energy spectra as functions of location (magnetic local time and corrected invariant latitude) for geomagnetic and solar activity levels. The model (Wüest et al., 2003; Sharber et al., 2003) has been developed using data from the NOAA-12 Total Electron Detector (TED) and Medium Energy Proton and Electron Detector (MEPED) (Raben et al., 1995) collected over the interval May 31, 1991 to Jul. 31, 2001, almost a full solar cycle. The data are binned according to magnetic local time, invariant latitude, and the geomagnetic and solar indices: Dst, Kp, PC, F10.7 (E10.7 can also be used as an alternate to F10.7). The model is made predictive by applying a predictive scheme to one of the activity indices, e.g., Dst or Kp (Wüest et al., 2003). The invariant latitude range is 40° to 90° with separate data stored for each hemisphere. The latitude bin size is 1°, and the resolutions for universal time and magnetic local time (MLT) are both 1 hour. The primary output of the climatology is the set of average precipitating electron differential flux values over the energy range 300 eV to ˜1 MeV at each invariant latitude/MLT cell.

Although the NOAA-12 climatology is now complete, occurrence statistics during severe storm times, i.e., at high values of Dst need to be improved. For example, in calculating total hemispheric power, we currently make a correction at high Dst values based on the power per unit area of filled cells. Accordingly we plan to augment the current climatology with NOAA-15 and NOAA-16 data under the Enhancement Program described in this patent application. Until the NOAA-15 and 16 data are added, algorithms using other climatological patterns will be employed as required.

4.1.4.1.2 Model Inputs:

The model uses Dst, F10.7 or E10.7 for inputs. Optional indices are Kp and PC.

4.1.4.1.3 Model Outputs:

The model produces particle fluxes, F(θ,φ,t), with spectral content binned on latitude (40°-90°) and magnetic local time and invariant latitude as an output for use as input for GAIM.

4.1.5 High Latitude Heating

4.1.5.1 Joule Heating

4.1.5.1.1 Model Description:

Joule power is closely associated with the level of geomagnetic activity. Chun et al. (1999) estimated hemispheric Joule heating with a quadratic fit to the Polar Cap (PC) Index, which is a proxy for the electric field imposed on the polar ionosphere by the solar wind (Troshichev et al, 1988). They assembled a set of 12,000 hemispherically integrated Joule heating values derived from the Assimilative Mapping of Ionospheric Electrodynamics (AMIE) mapping procedure (Richmond and Kamide, 1988) as a statistical ensemble for binning Joule power against geomagnetic activity. They noted the model underestimated Joule heating during strong storms. That concern is addressed by including another fit parameter to improve the power estimates during storm time. Using a series of multiple linear regression fits, the Joule heating can be better parameterized using the Polar Cap (PC) index and the Disturbance Storm Time (Dst) index. The Dst index can be thought of as a proxy for the electrical interaction of the nightside magnetosphere and ionosphere. We chose the regression parameters, PC and Dst, based on their: (1) association with geomagnetic activity; (2) hourly cadence; and (3) relatively long-term, uninterrupted availability (Knipp et al, 2004). As shown in Table 7, Joule power is dependent on quadratic fits to both PC and Dst. The variations in seasonal coefficients are in part due to seasonal changes in conductivity. We applied the seasonal coefficients to derive the Joule power.

TABLE 7
Fit Coefficients for Joule Power

| Fit | | Fit Using Absolute | |
|---|---|---|---|
| Season | Months | Values of PC and Dst | R² |
| Annual | January-December | JH(GW) = 24.89*PC + | 0.76 |
| | | 3.41*PC² + .41*Dst + | |
| | | .0015*Dst² | |
| Winter | 21 October-20 February | JH(GW) = 13.36*PC + | 0.84 |
| | | 5.08*PC² + .47*Dst + | |
| | | .0011*Dst² | |
| Summer | 21 April-20 August | JH(GW) = 29.27*PC + | 0.78 |
| | | 8.18*PC² − .04*Dst + | |
| | | .0126*Dst² | |
| Equinox | 21 February-20 April, | JH(GW) = 29.14*PC + | 0.74 |
| | 21 August-20 October | 2.54*PC² + .21*Dst + | |
| | | .0023*Dst² | |

The AMIE values which provide the foundation for the fits are calculated over a northern hemisphere grid (typically 2.0° in magnetic latitude, A, and 15° in longitude) using the product of the height-integrated Pedersen conductance and the square of the electric field value in each grid box. Integration over the grid from 50° A to the magnetic pole produces hemispherically-integrated values of Joule power. The correlation coefficients in Table 7 indicate that the PCDst combination can provide a good proxy of simple, large-scale Joule heating on a global scale. The geomagnetic power values provided here are consistent with an overall 15 percent geomagnetic contribution to upper atmospheric heating. We do not yet account for small-scale variability of the electric field, which may add considerably to the Joule heating tally during very quiet and very disturbed times. Neither do we account for neutral wind effects that contribute to the power budget when the ion flows are significantly different from neutral wind motions. Thus, the geomagnetic power estimates are conservative.

4.1.5.1.2 Model Inputs:

The model uses the Polar Cap (PC) Index and Disturbance Storm Time (Dst) index.

4.1.5.1.3 Model Outputs:

The model produces Joule heating (Qj) in GigaWatts (GW) as the globally integrated value. Latitude, longitude, and height distribution specification may be available at a later date. Joule heating is used by the 1DTD model.

4.1.5.2 OM2000

4.1.5.2.1 Model Description:

The OM2000 model (O'Brien and McPherron, 2002) provides real-time forecasting of the Dst index. The Dst index is a local time average of the depression in the horizontal component of the midlatitude magnetic field caused by a magnetic storm. Dst is a required input to models of the magnetospheric magnetic field which determine the structure of the radiation belts and ionosphere. The hourly Dst index is normally calculated once each calendar year after the year has ended. A higher time resolution version of this index called sym-H is calculated daily. Neither of these indices is available soon enough for real time forecasting of other phenomena. However, several empirical models have been developed that utilize real time observations of the solar wind at L1 to predict hourly Dst at the Earth. The first of these was created by Burton et al. [1975]. This model is extremely simple using only five constant parameters as shown in the following equations 1 and 2.

$$\begin{matrix}{D}_{st}^{*} = {D}_{st} - b \sqrt{{p}_{d yn}} - c & ( 1 ) \\ \frac{ⅆ {D}_{st}^{*}}{ⅆ t} = a ( {VB}_{s} - {E}_{c} ) - \frac{{D}_{st}^{*}}{τ} & ( 2 )\end{matrix}$$

Dₛₜ is the measured index, Dₛₜ* is the index after correction b for solar wind dynamic pressure (p_{dyn}) and for quiet time contributions to magnetogram base lines c. The second equation assumes that injection into the ring current is linearly proportional, a, to the solar wind electric field (VBₛ), and that decay is linearly proportional to Dₛₜ* through the decay rate τ. More recently (O'Brien and McPherron, 2000a, 2000b) and (McPherron and O'Brien, 2001) showed that both b and τ depend linearly on VBₛ.

These relations bring the total number of parameters in the model to nine. A final modification introduced by (O'Brien and McPherron, 2002) is a dependence of these parameters on the tilt of the Earth's dipole toward or away from the Sun through the Svalgaard function (Svalgaard, 1977). This modification brings the total number of parameters to 12. This model is able to explain ˜85 percent of the variance in hourly Dst.

Another hourly Dst forecast model has been developed by Temerin and Xinlin (2002). This model utilizes more than 30 parameters including thresholds, exponents, time delays, and constants of proportionality. For example, the constant term in the Burton and O'Brien and McPherron formulation is replaced by a function with five parameters. This model does somewhat better than the O'Brien and McPherron model explaining 91 percent of the Dst variance.

All models for Dst achieve most of their forecast ability by utilizing measurements of the solar wind at L1 30-60 minutes ahead of its arrival at the Earth. Another 20 minutes is added by the inherent delay of the magnetosphere in response to a change in VBₛ. The accuracy of the models is completely dependent on the accuracy of the upstream measurements, and the quality of the algorithm used to propagate the solar wind to the Earth.

As input to the Dst algorithm we assume the following. A module exists for processing real time data at L1 to obtain accurate density, velocity, and IMF B in GSM coordinates at 1-minute resolution. We assume in addition that a second module propagates this solar wind to the sub solar bow shock. The most accurate procedure for doing this is that described recently by Weimer et al., 2003. The algorithm begins by calculating at 1-minute resolution the parameters needed by the model. It then averages these parameters to 1-hour resolution for input to the model. It should be noted that no model has been developed for higher resolution measurements because of the difficulty of modeling nonlinear response functions.

The Dst model consists of a simple numerical integration of the equations presented above substituting the hourly averages of measured VBₛ and p_{dyn}, and the previously calculated value of Dst in the expression for the rate of change of Dst. The change in Dst is then simply the product of Δt and the calculated rate of change. This change is added to the previously calculated Dst to obtain the Dst forecast for the next hour. This integration must be initialized by a measured value of Dst. This can be done about once each day when the World Data Center in Kyoto releases the sym-H values for the previous day. The model would then utilize a file of past hourly averages of the inputs to integrate forward to the current time step. These new values of Dst would replace those calculated using an earlier value of measured Dst as an initial condition.

The UCLA group will provide a Dst module that accepts a file containing several hours of past solar wind values at 1-minute resolution, and the last available hour of sym-H calculations. If the data from L1 are not continuous we assume that the solar wind processing algorithm and the propagation algorithm have placed flags in the file so that the input data are a continuous time series. On-call, the Dst module will form an average of all available solar wind measurements in the preceding hour and return the forecast of Dst in the hour interval following the time of the call. If all data for the hour are missing the module will use the last available hourly averages for the calculation. Note that this extrapolation of previous data is the primary cause of inaccuracy in the forecast model. If the calls to this module do not correspond to UT hours, or are more frequent than 1-hour the module will use interpolation of previously calculated values of Dst to form the proper hourly average in calculating the derivative.

4.1.5.2.2 Model Inputs:

The model uses ACE and HAF B(x,y,z,t) in GSM coordinates as an input.

4.1.5.2.3 Model Outputs:

The model produces Dst (hourly values) for use by the SwRI and Joule heating models.

4.1.5.3 Ap

4.1.5.3.1 Model Description:

A real-time forecasting model of the daily Ap index has been developed (McPherron, 1998). The daily Ap index is currently the only magnetic index routinely forecast by the Space Disturbance Forecast Center of NOAA. The quality of the forecasts is low having a prediction efficiency of order ˜15 percent. A simple autoregressive filter utilizing persistence of yesterday's value and trend, and a 5-day running average of activity 27 days earlier is considerably better predicting ˜25 percent of its variance. An acausal ARMA filter utilizing persistence of yesterday's Ap and a moving average of three daily average solar wind velocities is better still predicting about 55 percent of the variance (McPherron, 1998). Unfortunately this filter requires tomorrow, today, and yesterday averages to predict today. This filter can be used only if forecasts of solar wind speed are available at least two days in advance of arrival at the Earth.

The Wang-Sheeley-Arge (WSA) model (Arge and Pizzo, 2000) forecasts the solar wind speed at 1 AU 3-5 days prior to arrival at the Earth. The output of this model can be convolved with the Ap ARMA prediction filter to obtain a 1-2 day ahead forecast of daily Ap. The quality of the Ap forecast depends on the quality of both the ARMA filter and the predicted speed profile. Errors in the WSA model are compounded by the Ap model. Professor McPherron is currently developing this prediction scheme under CISM sponsorship and will make the results of this external effort available to the system.

The UCLA group will develop two modules for predicting daily Ap based on the schemes discussed above. Both modules can be called once each day at the beginning of the UT day. The first module will implement an autoregressive filter. Input to the module will be a file of the last month of daily Ap measurements created by the NOAA SEC/USAF group at the Space Disturbance Forecast Center in Boulder, Colo. Output will be the forecast for the ensuing day.

The second module will be the ARMA filter using daily averages of the solar wind speed and the file of Ap measured during the previous month. The daily averages will be calculated internally in the module from predictions of the WSA model that are made publicly available at the NOAA SEC website in Boulder. The model output will be a sequence of Earth arrival times and predicted daily Ap values calculated each time the WSA model is updated (about every nine hours). The number of output samples preceding the time at which the module is called will vary depending on the profile of solar wind speed predicted by the WSA model at the solar source surface. A fast solar wind will give less lead time in the forecast of Ap at the Earth. Some effort will be required to synchronize the acquisition of new WSA forecasts and calls to this routine.

4.1.5.3.2 Model Inputs:

Input to the module will be a file of the last month of daily Ap measurements created by the NOAA SEC/USAF group at the Space Disturbance Forecast Center in Boulder, Colo. HAF V_{SW} are also available.

4.1.5.3.3 Model Outputs:

Output will be the Ap forecast for the ensuing day.

4.1.6 Neutral Thermosphere Winds

4.1.6.1 HWM93

4.1.6.1.1 Model Description:

The Horizontal Wind Model (1993) (Hedin et al., 1994, 1996) produces an empirical thermospheric wind velocity field. The following description comes from the HWM93 README file.

The HWM is an empirical model of the horizontal neutral wind in the upper thermosphere. It is based on wind data obtained from the AE-E and DE 2 satellites. A limited set of vector spherical harmonics is used to describe the zonal and meridional wind components. The first edition of the model released in 1987 (HWM87) was intended for winds above 220 km. With the inclusion of wind data from ground-based incoherent scatter radar and Fabry-Perot optical interferometers, HWM90 was extended down to 100 km and using MF/Meteor data HWM93 was extended down to the ground. Solar cycle variations are included (since HWM90), but they are found to be small and not always very clearly delineated by the current data. Variations with magnetic activity (Ap) are included. Mid- and low-latitude data are reproduced quite well by the model. The polar vortices are present, but not to full detail. The model describes the transition from predominately diurnal variations in the upper thermosphere to semidiurnal variations in the lower thermosphere and a transition from summer to winter flow above 140 km to winter to summer flow below. Significant altitude gradients in the wind extend up to 300 km at some local times. The model software is provided as one file HWM93.TXT; earlier versions (HWM87, HWM90) are also available from NSSDC on request. The software provides zonal and meridional winds for specified latitude, longitude, time, and Ap index.

4.1.6.1.2 Model Inputs:

The model uses F10.7 and Ap as inputs. Time-resolved E10.7 is a probable replacement for F10.7.

4.1.6.1.3 Model Outputs:

The model produces neutral thermospheric horizontal winds, U(θ,φ,z,t), as an output for use in the GAIM model.

4.1.7 Neutral Thermosphere Densities

4.1.7.1 J70MOD

4.1.7.1.1 Model Description:

J70MOD computes thermospheric temperatures at all times, latitudes, longitudes, and 90-1500 km altitude with solar and geomagnetic inputs. It corrects two global temperature parameters, i.e., the exospheric temperature, T_{∞} (600 km), and the inflection point temperature, T_{X} (125 km). As in the Jacchia 1970 (J70) model, the local temperature profile, T(z), as a function of altitude, z, is uniquely determined by T_{X} and T_{∞} The local values for T_{X} and T_{∞} are both corrected indirectly through a global parameter known as the nighttime minimum exospheric temperature, T_{C}, which is formed from solar driver inputs. This is used in J70 to describe the state of the entire thermosphere in response to solar extreme ultraviolet heating.

4.1.7.1.2 Model Inputs:

The model uses E10.7 or F10.7 and Ap as inputs through the MFD file (Tobiska, 2003). In addition, the DCA delta-temperature spherical harmonic coefficients can be provided for more accurate regional mass densities and temperatures.

4.1.7.1.3 Model Outputs:

The model produces mass density, ρ(θ,φ,z,t), as an output. This is used to scale the NRLMSIS and the 1DTD neutral densities by first creating a mass density of the latter models' outputs, then using the scaling ratios applied as a correction.

4.1.7.2 NRLMSIS00

4.1.7.2.1 Model Description:

MSIS86, MSISE90, NRLMSIS00 are provided in the public domain by work from A. Hedin and co-workers, including M. Picone at NRL. The following text is from the MSISE90 Readme file.

The MSISE90 model describes the neutral temperature and densities in Earth's atmosphere from ground to thermospheric heights. Below 72.5 km the model is primarily based on the MAP Handbook (Labitzke) tabulation of zonal average temperature and pressure by Barnett and Corney, which was also used for the CIRA-86. Below 20 km these data were supplemented with averages from the National Meteorological Center (NMC). In addition, pitot tube, falling sphere, and grenade sounder rocket measurements from 1947 to 1972 were taken into consideration. Above 72.5 km MSISE-90 is essentially a revised MSIS-86 model taking into account data derived from space shuttle flights and newer incoherent scatter results. For someone interested only in the thermosphere above 120 km, the author recommends the MSIS-86 model. MSISE is also not the model of preference for specialized tropospheric work but for studies that reach across several atmospheric boundaries.

The following text is from the NRLMSIS-00 Readme file:

The NRLMSIS-00 empirical atmosphere model was developed by Mike Picone, Alan Hedin, and Doug Drob based on the MSISE90 model. The main differences to MSISE90 are noted in the comments at the top of the computer code. They involve: (1) the extensive use of drag and accelerometer data on total mass density; (2) the addition of a component to the total mass density that accounts for possibly significant contributions of O+ and hot oxygen at altitudes above 500 km; and (3) the inclusion of the SMM UV occultation data on [O2]. The MSISE90 model describes the neutral temperature and densities in Earth's atmosphere from ground to thermospheric heights. Below 72.5 km the model is primarily based on the MAP Handbook (Labitzke) tabulation of zonal average temperature and pressure by Barnett and Corney, which was also used for the CIRA-86. Below 20 km these data were supplemented with averages from the National Meteorological Center (NMC). In addition, pitot tube, falling sphere, and grenade sounder rocket measurements 1947-1972 were taken into consideration. Above 72.5 km MSISE-90 is essentially a revised MSIS-86 model using data derived from space shuttle flights and newer incoherent scatter results. For someone interested only in the thermosphere (above 120 km), the author recommends the MSIS-86 model. MSISE is also not the model of preference for specialized tropospheric work. It is rather for studies that reach across several atmospheric boundaries.

4.1.7.2.2 Model Inputs:

F10.7 and Ap are the nominal inputs into MSIS-type models. Time-resolved E10.7 can replace F10.7.

4.1.7.2.3 Model Outputs:

Neutral densities N(θ,φ,z,t) of O, O₂, N₂, H, He, N, and temperature (T) are provided either as is or scaled using J70MOD mass densities, for use in the GAIM model.

4.1.7.3 IDTD

4.1.7.3.1 Model Description:

The 1-Dimensional Time Dependent (1DTD) (Tobiska, 1988) physics-based neutral species' density model incorporates physics-based time-dependent heating of the thermosphere as a function of EUV energy by wavelength I(λ₃₉,t), heating efficiency (ε), unit optical depth (τ(λ,z)), absorption cross section (σ(λ)), and density (Mᵢ(z)) of each neutral species. It accounts for molecular thermal conductivity, vibrational cooling by NO, CO₂, and O, and Schumann-Runge continuum heating through O₂ dissociation. 1DTD uses parameterized auroral electron precipitation (Q_{P}) and Joule heating (Q_{J}) to perturb the neutral densities as well as eddy (Q_{EC}) and turbulence heat conduction (Q_{EH}) for energy-related dynamics. These parameterizations provide order-of-magnitude estimates for energy from these sources and secondarily modify the neutral species' densities. The neutral species' densities generated with 1DTD physics will be used with J70MOD and NRLMSIS for operation validation. The 1DTD neutral species density code is at TRL 4; analytical functions and proofs-of-concept have been validated with MSIS-86 and J70 and a system was demonstrated at Space Weather Week in 2000. Standalone prototyping implementation, testing, and integration of technology elements has been completed with experiments conducted using full-scale problems or data sets.

4.1.7.3.2 Model Inputs:

The SOLAR2000 EUV energy flux I(λ₃₉,t) in the format provided by the s2k_output.txt file is the input required by the model. In addition, control parameters include the Ap and the solar zenith angle cosine, μ. Q_{J} and Q_{P} are input for non-solar heating and replace the Ap value.

4.1.7.3.3 Model Outputs:

The model produces n(z,t) for [O], [O₂], [N₂], [NO], [CO₂], [H], [He], and [N]. In addition, Q_{EUV}(Z), T(z), and ρ(z,t) are produced. Validating with the subsolar point 1DTD densities, the J70MOD mass density ratios can be used to create a global scaling grid applied to the neutral densities provided by NRLMSIS for use in the GAIM model.

4.1.8 Solar Irradiances

4.1.8.1 SOLAR2000

4.1.8.1.1 Model Description:

The SOLAR2000 (Tobiska et al., 2000) Operational Grade (OP) model (S2KOP) provides 1 AU adjusted or observed daily historical, nowcast, and forecast solar irradiance products. The OP model is run every hour on the SET proprietary server which also generates high time resolution irradiance forecast products such as the I(λ₃₉,t) spectral solar irradiances as well as the integrated irradiance proxy (E10.7) daily values. The high time resolution data is provided in 3-hour time bins that correspond to the 0, 3, 6, 9, 12, 15, 18, and 21 UT releases of the ap index and is updated once per hour. When the GOES-N data from the five EUV broadband detectors comes on-line (2008), the time resolution will be every 5 minutes which captures solar X-ray and EUV flare evolution. The high time resolution forecast is made out to 72 hours. The OP model provides data on demand (24/7) via a user account on a secure server. A typical file that is produced for the high time resolution data is the Modified Flux Data (MFD) bulletin (Tobiska, 2003) that provides the previous 48-hours of issued data and nowcast data as well as the 72-hour forecast data. The file contains a fixed-length metadata section describing the file name, the issued date and time (UT), the manufacturer and contact information, the units used for the file data, the data source and production location, and the missing data flag designator symbol. Parameters provided in this file are one line for each time record in column format that include time (UT time in YYYYMMDDhhmm format), S_C, F10, F81, LYA, L81, E10, E81, A_p, E3h, B3h, a3h, E1s, a1s, and SRC.

4.1.8.1.2 Model Inputs:

The model uses F10.7 and Mg II cwr as inputs. In the future, it will use NOAA GOES-N as an input.

4.1.8.1.3 Model Outputs:

The model produces a variety of spectrally-resolved and integrated solar irradiances including I(λ₃₉,t), E10, and the MFD files for use by GAIM and by any model that uses F10.7 as an input solar proxy.

4.2 Operational Data

The operational data sets are described in a manner similar to the operational models in section 4.1.

4.2.1 Ionospheric Data

4.2.1.1 Ground and Space GPS TEC

4.2.1.1.1 Data Description:

JPL produces total electron content (TEC) data from over 100 continuously operating GPS ground-based receivers in a global network. An additional 60 stations are being contemplated. Furthermore, the NOAA CORS network is adding more than 300 ground stations producing a very dense network of ground-based TEC data over the continental US.

Space GPS data obtained during GPS-LEO occultations offers global distribution combined with very high vertical resolution, therefore, complementing the ground network. Several GPS receivers in LEO are already operating (CHAMP and SAC/C) and several more are scheduled for launch in the next 1-3 years including C/NOFS, COSMIC (70° inclination 6 satellite constellation), ACE+ (a constellation of 4 satellites). The C/NOFS CORISS instrument will provide equatorial region TEC measurements and will be extremely useful for quantifying scintillation conditions.

4.2.1.1.2 Data Inputs:

The TEC measurements include JPL (global ground GPS), NOAA CORS(CONUS ground GPS), C/NOFS CORISS (equatorial satellite GPS), and eventual COSMIC (equatorial and midlatitude satellite GPS) as well as SBIRS Lo (global satellite GPS). These are slant path TEC.

4.2.1.1.3 Data Outputs:

The TEC measurements include JPL (global ground GPS), NOAA CORS(CONUS ground GPS), CHAMP, SAC/C, C/NOFS, and COSMIC. All data correspond to line-of-sight calibrated and absolute TEC measurements with a 0.1 TECU precision and 1-2 TECU accuracy. In addition, TEC data from LEO antennas looking upward (primarily used for navigation purposes) will be input into GAIM providing a strong constraint on the topside ionosphere and plasmasphere.

4.2.1.2 nₑ

4.2.1.2.1 Data Description:

Electron density profiles are provided by latitude, longitude, altitude, and time.

4.2.1.2.2 Data Inputs:

Multiple inputs into GAIM are used.

4.2.1.2.3 Data Outputs:

nₑ(θ,φf,z,t) is produced by GAIM.

4.2.1.3 Te and Ti (temperatures)

4.2.1.3.1 Data Description:

Electron and ion temperature empirical models are embedded inside the GAIM model.

4.2.1.3.2 Data Inputs:

Multiple inputs into GAIM are used.

4.2.1.3.3 Data Outputs:

Tₑ, Tᵢ are produced by GAIM.

4.2.1.4 UV (SSULI)

4.2.1.4.1 Data Description:

The SSULI UV instrument on a DMSP satellite will produce maps of altitude-resolved airglow from O/N₂ observations. Variations in this ratio are indicative of energy deposition. Fidelity of the airglow measurements can be validated with a derived effective 1-40 nm EUV flux (Qeuv) (Tobiska, 2002) that would be required to produce the observed airglow and SOLAR2000 produces an integrated 1-40 nm EUV energy flux time series (E1_{_{—}}₄₀) that will be used in validation.

4.2.1.4.2 Data Inputs:

SSULI UV airglow measurements are processed. In addition, an effective EUV flux will be produced and will be compared to E₁_{_{—}}₄₀ as a data validation.

4.2.1.4.3 Data Outputs:

The UV data is assimilated in the GAIM model.

4.2.2 Solar Wind

4.2.2.1 IMF B

4.2.2.1.1 Data Description:

Solar wind magnetic field magnitude and direction are available from the ACE spacecraft and HAF model.

4.2.2.1.2 Data Inputs:

Magnetograms and optical observations are input into HAF.

4.2.2.1.3 Data Outputs:

B(x,y,z,t) as produced by either ACE or HAF.

4.2.2.2 Photospheric Magnetogram

4.2.2.2.1 Data Description:

Photospheric magnetograms of the solar magnetic field source surface are primary data that provide information about the polarity of the solar photospheric magnetic field. They can be translated, through models, into current sheet specification and, in turn, characteristics of the solar wind.

4.2.2.2.2 Data Inputs:

NSO observations.

4.2.2.2.3 Data Outputs:

Photospheric magnetograms are used by HAF.

4.2.2.3 V_{SW}

4.2.2.3.1 Data Description:

Solar wind velocity is produced by the ACE spacecraft and by the HAF model.

4.2.2.3.2 Data Inputs:

ACE makes measurements and HAF uses magnetograms.

4.2.2.3.3 Data Outputs:

V_{SW} are produced by ACE and HAF.

4.2.3 Plasma Drifts

4.2.3.1 w

4.2.3.1.1 Data Description:

Plasma drift velocity magnitudes are specified by latitude, longitude, altitude, and time. They are produced by the DICM, HM87, W95, and SF99 models as well as measured by DMSP UVI and C/NOFS VER1 instruments for use in GAIM.

4.2.3.1.2 Data Inputs:

ACE and HAF IMF B are used to produce modeled plasma drift velocities at high latitudes while E10.7 and/or F10.7 are used for low latitudes.

4.2.3.1.3 Data Outputs:

w(θ,φ,z,t) is used in GAIM.

4.2.4 Particle Precipitation

4.2.4.1 Kp

4.2.4.1.1 Data Description:

Kp is a 3-hourly geomagnetic index provided though NOAA SEC.

4.2.4.1.2 Data Inputs:

Observing stations.

4.2.4.1.3 Data Outputs:

Kp is used in the SwRI model. SET provides a forecast conversion of 3-hourly Kp values to ap.

4.2.4.2 F

4.2.4.2.1 Data Description:

Low- and high-energy particle precipitation, F(θ,φ,t), contributes energy to the polar regions. We use two methods to ensure a transition from climatology to weather. First, the 1DTD model and GAIM both use parameterization of particle precipitation to achieve proper scales of energy input from this source. Second, a statistical, climatological model of electron precipitation that is very convenient for operations has been compiled from the NOAA-12 data by researchers at SwRI (Wüest et al., 2002).

The following text comes from the NOAA SEC web site description:

The Space Environment Monitor (SEM) that is regularly flown on the NOAA POES (formerly TIROS) series of low-altitude (850 km), polar-orbiting (98 degree inclination) spacecraft contains two sets of instruments that monitor the energetic charged-particle environment near Earth. An upgraded SEM, called SEM-2, began operations with the launch of NOAA-15 and is currently the prime source of observations.

The Total Energy Detector (TED) in SEM-2 provides the data used to determine the level of auroral activity and generate the statistical maps presented on NOAA SEC's ‘POES Auroral Activity’ website. This instrument monitors the energy fluxes carried into the atmosphere by electrons and positive ions over the energy range between 50 and 20,000 electron Volts (eV). Particles of these energies are stopped by the atmosphere of the Earth at altitudes above 100 km, producing aurora. The instrument design utilizes cylindrical, curved-plate electrostatic analyzers to select (by impressing a variable voltage between the analyzer plates) the species and energy of those particles that are permitted to reach the detector. Those particles that pass through the analyzer are counted, one by one, by the detector (a Channeltron open-windowed electron multiplier). Eight such detector systems are included in the SEM, four to monitor positive ions and four to monitor electrons. They are mounted in groups of four, one group viewing radially outward from Earth and the other viewing at 30 degrees to the first. Whenever the satellite is poleward of a geographic latitude of about 30 degrees, all eight detectors view the charged particles that will be guided by the geomagnetic field into the atmosphere below the satellite. A satellite data processing unit converts the Channeltron responses to measures of integrated power flux; these are telemetered to the ground along with crude information about the energy distribution of the electrons and positive ions. Data processing on the ground combines observations from the eight instruments to obtain the total power flux carried into the atmosphere by these particles.

The second instrument in the second-generation SEM-2 is the Medium Energy Proton and Electron Detector (MEPED) which provides the measurements used to create the plots on NOAA SEC's ‘POES Energetic Particles’ website. This instrument includes four solid-state detector telescopes, two to measure the intensity of electrons between 30 and 1000 keV and two to measure the intensity of protons (positive ions) between 30 and 6900 keV, as well as solid-state “dome” detectors that measure the intensities of protons 16-275 MeV.

The solid-state detector telescopes are mounted in pairs. One pair views radially outward from Earth to monitor particles that will enter the atmosphere in the polar regions; the other pair is mounted at nearly 90 degrees to the first to view charged particles that will “magnetically mirror” near the satellite. The field of view of each detector system is only 30 degrees so that the angular distribution of the particles may be determined. These detectors are designed to monitor the intensities of energetic particles in Earth's radiation belts and during solar particle events.

In addition, the MEPED contains “dome” detectors with very large fields of view (nearly 180 degrees) and are mounted on the side of the spacecraft facing away from Earth to monitor particles incident upon the atmosphere. These detectors are designed to detect and monitor energetic solar particles that cause severe ionospheric disturbances during solar particle events.

4.2.4.2.2 Data Inputs:

Dst, PC, Kp, F10.7 and E10.7 are inputs for the SwRI model; POES Pe, Pp measurements come from NOAA.

4.2.4.2.3 Data Outputs:

F(θ,φf,t) is used by the GAIM model.

4.2.4.3 Pe, Pp, and Qp

4.2.4.3.1 Data Description:

Instruments on board the Polar-orbiting Operational Environmental Satellite (POES) continually monitor the protons and electrons power flux. Fuller-Rowell and Evans (1987) developed a technique that uses the power flux observations obtained during a single pass of the satellite over a polar region (which takes about 25 minutes) to estimate the total power deposited in an entire polar region by the 50 eV to 20 keV particles. Relationship to particle heating global value must still be understood and is a possible future activity.

4.2.4.3.2 Data Inputs:

POES measurements.

4.2.4.3.3 Data Outputs:

Pe (electron precipitation power) and Pp (proton precipitation power) are used by the GAIM model.

4.2.5 High Latitude Heating

4.2.5.1 Ap

4.2.5.1.1 Data Description:

Ap is a daily planetary geomagnetic index provided though NOAA SEC and ap is the 3-hourly index.

4.2.5.1.2 Data Inputs:

The McPherron model (1998) uses historical Ap files and V_{SW}.

4.2.5.1.3 Data Outputs:

Daily Ap from the McPherron ARMA model algorithm with transform to 3-hourly using Kp scaling from USAF. As part of the translation of daily Ap to 3-hourly ap forecasts, SET will use a conversion algorithm that can unit scale daily Ap relative to the USAF forecast 3-hourly Kp values.

4.2.5.2 Qj

4.2.5.2.1 Data Description:

Joule heating is a derived quantity produced by the Knipp model. It is used by the 1DTD model.

4.2.5.2.2 Data Inputs:

Dst and PC are the Knipp model inputs.

4.2.5.2.3 Data Outputs:

Q_{J} is used by the 1DTD model.

4.2.5.3 Dst

4.2.5.3.1 Data Description:

The Disturbance Storm Time (Dst) index can be thought of as a proxy for the electrical interaction of the nightside magnetosphere and ionosphere. Kyoto provides the near real-time data stream while predictions are made by UCLA and other groups.

4.2.5.3.2 Data Inputs:

Kyoto provides the near real-time data stream while predictions are made by UCLA and other groups.

4.2.5.3.3 Data Outputs:

Hourly Dst from the UCLA prediction method.

4.2.5.4 PC

4.2.5.4.1 Data Description:

The PC-index, a proxy for the electric field imposed on the polar ionosphere by the solar wind, is based on an idea by Troshichev and developed in papers including Troshichev et al. 1988. It is based on an assembled a set of 12,000 hemispherically integrated Joule heating values derived from the Assimilative Mapping of Ionospheric Electrodynamics (AMIE) mapping procedure (Richmond and Kamide, 1988) as a statistical ensemble for binning Joule power against geomagnetic activity. The procedure may underestimate Joule heating during strong storms. The data from 1975-1993 are published in Report UAG-103 and monthly Thule plots appear in SGD since October 1993.

An additional description comes from the NOAA SGD Explanation of Data Reports. The Geomagnetic Polar Cap (PC) Index (PC) is an index for magnetic activity in the (P)olar (C)ap. It is based on data from a single near-pole station, and aimed to monitor the polar cap magnetic activity generated by such solar wind parameters as the southward component of the interplanetary magnetic field (IMF), the azimuthal component of the IMF B(y), and the solar wind velocity, ν. The station Thule, located in the village Qaanaaq in Greenland at 86.5 geomagnetic invariant latitude, fulfills the requirement of being close to the magnetic pole in the northern hemisphere. The station Vostok at 83.3 does the same in the southern hemisphere. The PC index is derived independently for these two stations. The northern index is most commonly used and work continues in the scientific community to reconcile the northern and southern indices. Currently, the northern polar cap index is available only at the end of the UT day. The southern PC index has been available every 15 minutes but the station producing the Index, Vostok, may be closed.

4.2.5.4.2 Data Inputs:

Magnetic field measurements.

4.2.5.4.3 Data Outputs:

PC is used in the SwRI and Joule heating models.

4.2.6 Neutral Thermosphere Winds

4.2.6.1 U

4.2.6.1.1 Data Description:

Horizontal (meridional and zonal) wind magnitude by latitude, longitude, altitude, and time are produced by the HWM93 model.

4.2.6.1.2 Data Inputs:

F10.7, E10.7, and Ap.

4.2.6.1.3 Data Outputs:

U(θ,φf,z,t) is used by the GAIM model.

4.2.7 Neutral Thermosphere Densities

4.2.7.1 DCA

4.2.7.1.1 Data Description:

The DCA model was developed to operational status through the USAF HASDM project and is described in an AIAA abstract by Stephen J. Casali and William N. Barker, “Dynamic Calibration Atmosphere (DCA) For The High Accuracy Satellite Drag Model (HASDM),” (2002):

“The Dynamic Calibration Atmosphere (DCA) represents a first phase of the High Accuracy Satellite Drag Model (HASDM) initiative. DCA uses tracking data on a set of calibration satellites to determine corrections to the Jacchia 70 density model in near real-time. The density corrections take the form of spherical harmonic expansions of two Jacchia temperature parameters that enhance spatial resolution. [Their paper] describes the DCA solution over the first half of 2001 and its application to forty evaluation satellites. Improvements due to DCA in ballistic coefficient consistency, epoch accuracy, and epoch covariance realism are measured and demonstrated.”

U.S. Space Command is in the final stages of placing the DCA algorithm into operations at TRL 9 as it has gone through extensive development, testing, validation, and implementation during 2001-2004. The system delivery has occurred with data now being produced. We note that these data are not available to the community outside of Space Command in real-time. An agreement would be required between DoD agencies to permit use of the DCA coefficients in an AFWA rack-mount system of this design. The system we are designing runs in the lower accuracy mode with only the J70MOD. The high accuracy capability with the inclusion of DCA coefficients would be a future enhancement activity.

4.2.7.1.2 Data Inputs:

The model uses Space Surveillance Network (SSN) real-time data. SSN data is the composite data set of all NORAD tracked objects and their Two-Line Elements (TLE).

4.2.7.1.3 Data Outputs:

The model produces a delta-temperature coefficient file (spherical harmonic) for inclusion into the J70MOD model to correct the climatological values for the current epoch or forecast out to 72 hours.

4.2.7.2 p

4.2.7.2.1 Data Description:

Thermospheric mass density by latitude, longitude, altitude, and time are produced by the J70MOD model or, in altitude and time, by the 1DTD model.

4.2.7.2.2 Data Inputs:

E10.7, Ap, and I(λ₃₉,t) are inputs.

4.2.7.2.3 Data Outputs:

ρ(θ,φ,z,t) is used in a scaling array as a correction term for the NRLMSIS mass densities then neutral densities; it will be validated by 1DTD.

4.2.7.3 N

4.2.7.3.1 Data Description:

Neutral thermospheric densities by species and altitude, latitude, longitude, and time are provided by NRLMSIS and 1DTD. These are climatological values and must be transformed to mass densities, then corrected at the current epoch by J70MOD mass densities, and retransformed back to neutral densities.

4.2.7.3.2 Data Inputs:

E10.7, F10.7, Ap, and I(λ₃₉,t) are inputs.

4.2.7.3.3 Data Outputs:

N(θ,φf,z,t) is used by the GAIM model.

4.2.8 Solar Irradiances

4.2.8.1 EM Observations

4.2.8.1.1 Data Description:

Electromagnetic field observations (EM obs) are solar X-ray, optical, and radio emission observations that provide information related to Coronal Mass Ejections (CMEs) and are monitored by ground observatories (National Solar Observatory) or by spacecraft (GOES SXI, YOHKOH, SOHO).

4.2.8.1.2 Data Inputs:

Observations.

4.2.8.1.3 Data Outputs:

X-ray, visible, and radio emissions are used by the HAF model.

4.2.8.2 F10.7

4.2.8.2.1 Data Description:

F10.7 is the daily value of the 10.7-cm solar radio emission measured by the Canadian National Research Council Dominion Radio Astrophysical Observatory at Penticton, BC, Canada. The “observed” value is the number measured by the solar radio telescope at the observatory, is modulated by the level of solar activity and the changing distance between the Earth and Sun, and is the quantity to use when terrestrial phenomena are being studied. When the Sun is being studied, it is useful to remove the annual modulation of F10 by the changing Earth-Sun distance and the “1 AU adjusted” value is corrected for variations in the Earth-Sun distance, giving the average distance. Penticton measures the F10, NOAA SEC reports the F10, and numerous organizations, including SET, forecast the F10. Its units are solar flux units (sfu) or 1×10²² Watts per meter squared per Hertz. Normal practice is to refer to the value as “F10.7” but F10 is often used here as an abbreviation.

4.2.8.2.2 Data Inputs:

Observations.

4.2.8.2.3 Data Outputs:

F10.7 is used in multiple models as a solar energy input.

4.2.8.3 Mg II cwr

4.2.8.3.1 Data Description:

The Mg II core-to-wing ratio (cwr) data is available on a daily basis from the NOAA Space Environment Center (SEC) (Viereck et al., 2001). It is the h and k line emission from Mg II and found in the 280 nm absorption feature of the solar spectrum. The ratio of the h and k line variation to the continuum emission at the wings of the absorption feature provides an excellent and highly precise method of determining solar chromospheric irradiance (full-disk) variability. We note that the solar EUV emission responsible for the formation of the ionosphere and heating of the neutral thermosphere comes primarily from the same solar temperature region (chromosphere) as the Mg II emission and this is why it is such a good proxy.

4.2.8.3.2 Data Inputs:

NOAA-16 SBUV Mg II core-to-wing ratio data is provided operationally at 0720 UT daily. The NOAA-17 SBUV Mg II cwr data is operational and being validated at NOAA SEC at 12 hours offset to the NOAA-16 data.

4.2.8.3.3 Data Outputs:

Community project (NOAA-coordinated by R. Viereck) Mg II cwr daily values are operationally used by the SOLAR2000 model.

4.2.8.4 GOES-N

4.2.8.4.1 Data Description:

The GOES-N EUV broadband data will become available through NOAA SEC in 2005-2006. There are five broadband EUV sensors in the instrument package and these data will be translated into an EUV solar spectrum with up to 5-minute time resolution which is beneficial for real-time solar EUV flare monitoring.

4.2.8.4.2 Data Inputs:

Measurements.

4.2.8.4.3 Data Outputs:

GOES-N EUV will be used by SOLAR2000 to produce spectral and integrated EUV irradiances.

4.2.8.5 I

4.2.8.5.1 Data Description:

I(λ₃₉,t) is the daily value of the solar EUV spectral irradiances in 39 wavelength groups and lines. In this system they are reported as photon or energy flux.

4.2.8.5.2 Data Inputs:

F10.7 and Mg II cwr are currently used to derive the irradiances, then GOES-N EUV data after 2005.

4.2.8.5.3 Data Outputs:

I(λ₃₉,t) is used by the GAIM model.

4.2.8.6 E10.7

4.2.8.6.1 Data Description:

Solar EUV energy flux between 1-105 nm is integrated, regressed with F10.7 over 3 solar cycles, and reported in F10.7 solar flux units (sfu) (Tobiska, 2001). This proxy is generated by the SOLAR2000 model and reports the same energy content as the full solar irradiance spectrum used by physics-based models.

4.2.8.6.2 Data Inputs:

F10.7, Mg II, and GOES-N are inputs.

4.2.8.6.3 Data Outputs:

E10.7 is used as a high time resolution substitute for F10.7 in operational models. There has been ongoing research over the past four years that has validated and verified the use of E10 in place of F10. In most daily applications, E10 and F10 perform nearly the same although most applications are derived using F10.7. However, the advantage of E10.7 is that time resolution and consistency with actual solar irradiances is obtained and this advantage is used in the system. All modules that normally use F10.7 will still be able to use that parameter; part of the validation work will be to ensure that E10.7 provides an operational advantage. Where this is not the case, F10.7 will be used.

4.3 Operational Forecast System

4.3.1 System Concept of Operations

There are two architecture approaches that are being developed for this operational ionospheric forecast system. One is primary and one is secondary. These approaches have emerged from a Unified Modeling Language (UML) “use-case” point of view which is described in more detail below as related to this system; the approaches also derive from the SET process for developing operational systems life cycles.

The primary approach is a distributed network based upon an Operational Database Management System (ODBMS) architecture. The key elements are: (1) an input data stream from third parties; (2) a client server that handles asynchronous file exchanges between geographically separated models hosted on separated prime and backup computers; (3) a real-time repository database for dynamic data sets; and (4) a customer server interface for access to real-time and forecast ionospheric parameters. Strengths include fault-tolerance and system flexibility. Risks include susceptibility to network disruptions and management complexity for distributed systems.

The secondary approach is a rack-mount, clustered turn-key system based upon a central server and database at one physical location that runs continuously and is linked to other local computers where all models reside. The server/database system's software languages and data interface routines collect the proper input data sets that are needed to provide real-time and forecast ionospheric parameters. The strengths of this system include information security and control at a single site. Risks include limitations to system upgrades and susceptibility to environment failures at the location of the rack-mount/turn-key system.

This patent application describes the distributed network system since it contains all components that are required by the rack-mount/turn-key system. Once a distributed network is functional, the porting of models, server, and database functions to a rack-mount “system-in-a-box” is relatively straightforward. The rack-mount system can be considered a derivative of the distributed network.

Recalling that the top level geophysical information flow has data and model linkages as a function of discipline area, data source, model host institution, and input/output data designation organized through data streams, we now describe the concept of operations that ties this architecture together.

The raw operational input data is collected from third parties by a client server located at Space Environment Technologies (SET). The server's software (described in section 4.3.2.3) creates metadata tags for all data objects and deposits the data object combined with its metadata as a “data suitcase” into the dynamic section of the database for use by models or users. Models, running at their appropriate geophysical cadences, are developed and hosted at SET and at partner institutions including USC (and their partner, JPL), EXPI, and SwRI. Requests for data inputs by models are made to the client server which then extracts and forwards the requested past, present, or future data suitcase to the requester. Outputs from the models are collected by the client server and stored in the dynamic database for use by other models.

Customers will access the data products by making requests to the server using either operational application software for automated server connections, a capability SET now provides for its SOLAR2000 Professional Grade model, or browsers for manual, interactive sessions. For example, a customer may want electron densities for a particular time, latitude, longitude and the information content of these data objects would be provided “just-in-time.” The use of dynamic metadata allows traceability for all I/O requests from models, customers, or users.

It is likely there would be an unmanageable risk if one were to try running the models in a synchronized, end-to-end manner. There are numerous potential single points of failure which could lead to system execution times longer than the anticipated cadence. In addition, with synchronized runs, there is a susceptibility to catastrophic failure in the event of component failure. We have avoided this risk by incorporating a key design philosophy: models are run asynchronously and linked through dynamic data input and output.

4.3.1.1 Functional System Design

Using the philosophy of asynchronously linked models within a dynamic data flow, the software architecture embodies an additional guiding concept: produce accurate real-time and forecast ionospheric parameters while maintaining output data integrity even with component failures and data dropouts or latency. A corollary design practice is used: no single points of failure, data dropouts or latency will stop the operational generation of real-time and forecast ionospheric information. This guidance implies that component failures, data dropouts, and data latency are identified, reported, and corrected where necessary such that the largest risk for data quality is its graceful degradation. As mentioned earlier, we use the term “graceful degradation” to mean that climatologically valid data continues to be produced but that the enhancements of time resolution, spatial detail, and small error are sacrificed. In other words, component failures and data communication interrupts do not produce catastrophic failure.

To implement the concept of operations philosophy, we begin with a four-tier architecture encompassing the major components of the system:

Tier 1—database;

Tier 2—client server;

Tier 3—client (model host); and

Tier 4—customer access.

The system's core component is the tier 1 database where all relevant information for all models is stored and accessible at any time. It is not an archival database but an operational one, dynamically maintaining real-time I/O capability with wrapped data objects that come from remote data sources or from the most recent models' outputs. Geophysical information of any time domain is extracted from a data object using a “just-in-time” (JIT) access philosophy to ensure that the most up-to-date information is passed to the requesting user. As data age, i.e., those data older than 48-hours, they are removed from the operational database to off-line storage in a separate archival facility to be built.

The existence of this database and its guaranteed accessibility is one of the key components to making this operational system work. An extremely reliable system (greater than 99.9 percent uptime) is the design goal using Unix-based computer systems combined with RAID disk arrays; the SET distributed network components are located at a Class A data center in Denver, Colo.

The tier 2 client server is designed as set of prime and backup computers controlling all access into and out of the core database and the client tier, i.e., the compute engines for the models regardless of their physical location. It executes software that receives and transmits data objects to and from the requesting models. Java software on the client server produces metadata tags that become attached to the data objects and this enables unambiguous identification of data in past, present, or future time domains as well as data type definitions, sources, uses, uncertainties, and validations. As a result, validation tests can be built into the software to permit automated alternative actions to be performed in the event of exceptions to normal operations. The client server also tracks, logs, and reports on the operational state of the entire system. Tight control on external access to the database through the server alone minimizes system security risks.

The tier 3 clients are the ensemble of partnering institutions' prime and backup model host computers. The machines are dedicated to operationally running specific models and to request input data from the server tier. The output data objects from this client tier are transmitted to the server tier for deposit into the core database tier. Compute engines also reside at the same location as the server and database; these computers run scientific models that have been developed by team members where the latter do not desire to host an operational system themselves.

The tier 4 customers are customer user computers that are permitted to query the server tier for information regarding past, present, or future ionospheric and other space weather parameters. These computers can be non-server or non-client machines at SET and team institutions or can be external computers, e.g. CISM.

4.3.1.2 Physical Architecture Design

The four-tier system design binds the basic system development process and operations into the physical architecture. It allows modelers and computer software engineers to separately develop, improve, and maintain models that have been transitioned from research into operations. The four-tier concept implements the benefits of flexibility and modularity at the top level system architecture.

In the functional system design, the client server, database, and compute engine will be on separate multi-processor Unix-based machines co-located at the same SET facility mentioned above. The system architecture is designed as a real-time scalable platform that accommodates intermittent and asynchronous data I/O. The Operational DataBase Management System (ODBMS) design (tier 1) uses state-of-the-art database management COTS prototyping tools (MySQL) and handles data I/O objects via secure, asynchronous local area network (LAN) ethernet protocols. The client model host machines (tier 3) at team members' facilities contact the central client server (tier 2) for provision of input data to unique directories or extraction of model output data objects from specified directories to be transferred to the database. The customer (tier 4) access is external to SET and team members' operational facilities. The access point for the customer tier is from an application running on customer systems that requests data from the client server, e.g. an automated server operating a batch cron job or manual browser.

In terms of the physical layout of the distributed network operational system, the SET computers consist of the database, client server, and compute engine and reside at one facility. The team members separately provide access via the internet or other dedicated communication lines to their client LANs that link with their model compute engine system and its backup. Development workstations are operationally off-line for all institutions.

The functional system design and physical architecture rely, in part, upon existing SET and team members systems. These must be integrated with new components to meet the four-tier design configuration. A summary of the principal roles and locations of each of these computer systems is:

1. Client and SET Development Computer(s)

a) provide a restriction-free environment for developers to write code and perform unit testing prior to final testing and implementation; and
b) are located at the developer's site and managed by the responsible team member.
   2. Client Model Computers
a) are the principal client systems for running the team members' models, for communicating with the central SET server to exchange data, and for communicating with local area networks;
b) are strictly operational platforms that run only tested code using operating system software and application software compatible with central server requirements; and
c) are located at the client team members' sites (remote if the test/backup system is local).
   3. Client Test/Backup Computers
a) are a backup system at remote sites in the event the primary model client computers fail;
b) serve as a final test platform prior to implementation in an operational environment; and
c) are located at the same site as the development and model systems.
   4. SET Client Server Computer
a) is the central gateway for all input data, client model output, distributed sites, and customers;
b) is the secure gateway to the ODBMS computer; and
c) is located at a Class A data center with physical security, redundant power and network, off-site backup sites, and 24/7 network security staff.
   5. SET Model Compute Engines
a) are machines that run models located at the SET central site and perform other compute-intensive tasks;
b) are optimized for compute speed to ensure that the server and ODBMS computers are not overloaded;
c) are located at the same site as the SET central client and DBMS computers; and
d) depending upon performance requirements, multiple compute engines running different/same models can be combined or separated.
   6. SET Database Computer
a) only runs ODBMS software and stores data on local RAID disk systems; and
b) is located at the same site as central SET client server and compute engine computers.
   7. Central Backup Computers
a) are a backup system for the SET central site in the event of central client server, compute engine, or ODBMS computers failure;
b) serve as final test platforms prior to implementation in an operational environment; and
c) are located on a separate WAN network and internet domain as well as being physically and geographically removed from the remote client computer; this mitigates homeland security, network outage, and power failure risks.

The system requirements for machine speeds, software, memory requirements, code execution durations, server data exchange protocols, inputs, outputs, cadences, interface format specifications, file sizes, unit designs, integration plan between the server, ODBMS and units, modularity concept for parameter or model substitution, test plans, maintenance procedures, and the upgrade framework are designed to utilize new technology, physics advances, or new collaborations. These items would be detailed in a System Requirements Document.

4.3.1.3 The UML/OO Design Process

Remote client models, model input and output data objects, database, and data communications are implemented with a networked architecture through the use of encapsulating Java software objects. We summarize the design of encapsulating software in this section using Unified Modeling Language (UML) notation. UML is used in the design of the operational system because it provides methods to clearly illustrate the complex arrangements of data and models in a robust system.

UML and its related object-oriented concepts assume that the reader is familiar with UML Object-Oriented (O) design language. Even though UML has a well-defined taxonomy where OO software (Java, C++) can be directly written using UML diagrams, diagrams are also meant to be readable by those unfamiliar with UML terminology. For objects and methods in our UML diagrams, we use obvious names such as “F10inputObj,” “DateTimeClass,” and “getData.”

A complete UML design precedes the actual software programming and requires four types of diagrams specifying the operational software requirements: (1) use-case diagrams which are a thumb-nail, top-level view of all the system actors (people and subsystems) and their activities; (2) physical design diagrams (also called deployment diagrams) showing the relationships between computers and their communication lines; (3) class and object diagrams (also called logical diagrams) which significantly expand on key components in the use-case diagrams and which largely define all the software objects attributes and methods; and (4) activity diagrams which show how operational scenarios are addressed. During the iterative diagramming process we have completed, loosely-coupled small abstract objects have become increasingly detailed with attributes, methods, and other OO elements.

The detailed design of all OO elements are being completed. However, as examples, key Use Cases as applied to input/output data, abbreviated Class definitions that expand on Use Cases, and activity diagrams that address specific operational scenarios are described below. The UML conventions for naming the components in our diagrams are based on Sinan (1998) and Booch (1994).

The input/output data objects present a large software design challenge in this system because the collection of models have differing run cadences and complex, interdependent linkages. Critical communication risks have been identified related to data stream outages or delays due to model failures, data concurrency and latency, computer and network failures, and software development and maintenance failures. We employ design patterns that are tailored to the data object requirements of a four-tier architecture to mitigate the risks.

4.3.2 Key Software Components

From the concept of operations, functional system design, physical architecture design, and UML/OO discussion, a number of “actors,” i.e., component systems that interact with other systems, have been identified. These are the server and database computers, compute engines or client host computers, as well as models and data which are all active within the component systems. For example, a client computer will communicate with the central server to access the database for getting input data and for delivering model results. Identifying these actors and their activities in a use case diagram allows us to identify objects that must be logically encapsulated. This lays the basis for creating software that glues together a data communication system. We next discuss these key components and their relationship to data and model object properties and system redundancy.

4.3.2.1 Data and Model Object Properties

A first data or model object property is encapsulation since input and output data objects and model objects are encapsulated as single objects. A data object, for example, can contain a scalar, vector, or tensor that represents a past, present, or future time domain. The metadata provides information about the data or model and can be examined by system components to determine if there is a need to unpack a data object.

Persistence of a unique data object means that it remains unchanged during its path through the entire system. Data objects have the property of persistence since common operations are performed on them such as query functions, i.e., obtaining the time the data were created, determining which time domain they represent, and deciding whether or not they contain valid data. For example, a daily F10.7 value is associated with a 2000 UT creation time at the Penticton observatory. In addition, a forecast F10.7 representing the same day's 2000 UT Penticton value will have been created the day before by the SET or NOAA SEC/USAF forecast models. The properties of forecast or measured F10.7 must be identified, and the times associated with these two values also differ from the storage time when it is written into the database or the time it is used by a model. Thus, a central server is needed to dynamically maintain the states of the data or model objects' properties that are common to the ensemble of client models.

The activities of the central, client server are oriented to data and model objects. At any given instant each data object has several types of times associated with it, e.g., the time the data represents and the time the object was created. The central server is designed to use a top-level “daemon,” i.e., a process that is always running in memory, that sends and receives data objects, dynamically validates data objects, and assigns data stream identifier tags to the data objects based on their time properties.

Finally, a data or model object has the property of universality. A data or model object is used or contained by nearly all components of the system and a central server is needed to maintain traceability of the data and model objects' properties that are common to the ensemble of client models. Universality for data objects also means that a data object's changing characteristics can be incorporated as they are used or modified by each model. We note that the input or output use of a data object is not a property; it may be either depending only upon how a particular model relates to it.

4.3.2.2 System Redundancy

Redundancy is an important part of the system design for a robust concept of operations. A first implementation of redundancy that addresses an operational risk in maintaining forecast data availability is to ensure the data stream flow. There are two data streams and the system must recognize a data object as belonging to either a primary “A” or secondary “B” data stream. The primary “A” data stream contains enhanced data by virtue of its finer time resolution, spatial detail, or reduced uncertainty. The drawback is that some of these data sets may become unavailable for a variety of operational reasons. The secondary “B” data stream contains core data that is fundamental to maintaining climatology related to the ionosphere. These data are always available, either as measured (past or current data) or modeled (current or future data). The redundant data stream attribute is a major design feature of the entire system and all data objects belong to either the “A” or “B” stream.

The data stream concept is separate from the concept of primary and backup computers which is also a redundancy method we use. Just as two data streams mitigate the risk to ionospheric output data availability by providing climatologically valid output when enhanced data is not available, we mitigate the risk of network communications errors from component failures, data outages, latency, or concurrency by using a network switch. This feature ensures that the communication lines are open between primary and backup systems at both the server and client tiers.

A network switch computer links between prime and backup client servers for a TRL 9 operational system. The network switch is physically separate from both the primary and backup systems, dynamically maintains URL pointers, and has the single function of determining what systems are running and then routing the client/server communications accordingly. Additionally, customer and client machines can have their own logic to select an alternative system.

The system design can be extended to use the network switch concept but this level of redundancy are not be implemented for the TRL 8 system demonstration. The network switch redundancy option is most applicable to a distributed network concept of operations. For the rack-mount turn-key system, an alternative option for maintaining open communication lines is to utilize dedicated T1 lines with external data sources. This is another solution for mission critical operations.

A third system-level redundancy implementation that mitigates the operational risk to data quality and availability is the concept of dual models. In sections 4.1 and 4.2, one notices that some of the space physics models provide similar data sets. Some of the models are most useful for the climatology “B” stream and some models for the enhanced “A” stream. Dual models (along with similarity of data types) are a type of redundancy we provide in conjunction with the two stream concept.

4.3.2.3 Server and Client Use Cases

From the key components of data object activity, we define the data object use cases and the activities surrounding them. We focus here on two of the principal actors of the system: the server and its clients.

The principal activities of the central client server includes ODBMS and client communication, external input retrieval, data object metadata updates, and validation. The server's daemon actions are related to the “actors” (tiers) (PrimaryServerDaemon) with parallel activity from the ODBMS side. The main server program, the daemon, is always running and is responsible for communicating with clients, detecting changes in data objects as they are modified by models, deciding what actions to take, accessing the database, and invoking the TimeStateDriver (see discussion below).

Besides storing data objects, the ODBMS requires from all data detailed definitions about its properties. This information is contained in the data definition tables which are filled with the dynamic content of the metadata carried along with each data object. Furthermore, all the activities performed by clients, validation processes, and other dynamic metadata attributes are contained within the database and this provides dynamic traceability for all the clients, models, and data.

The use case diagram of the client system that runs its model on a host computer is just a single model using well-defined input data and its own pre-defined output format. In this case it is using disk files to store this information.

A typical feature of operational models that have evolved from research models is that they all expect clearly defined data meanings and formats. Since models in the system have that heritage, an intentional design philosophy is to modify the models as little as possible. Model developers should be free to focus on their model's improvements, not on all the intricacies of the data communications. Furthermore, altering the software within a legacy program can easily introduce bugs. Therefore, the model is “wrapped” in software to handle all external needs including validation algorithms that can alert dependent subsystems of the existence of potential problems. Java algorithms that wrap the models for execution and data I/O are generically called model wrapper codes.

4.3.2.4 Classes

In OO Programming (OOP) languages (Java) we employ classes and objects that encapsulate the data, models, and other subsystems. Each has a common set of attributes and methods that can differ depending on the state of those objects. We can simply “extend” an abstract class or assemble class components to reflect these changing attributes and thus retain many of the prior state properties. In other words, we add or change only those properties that are required. Code-reuse and reliability is gained when we extend classes and objects.

For example, a data object changes its state when it changes its current time attribute from nowcast to historical. Rather than create a completely new data object, we want to retain most of its prior attributes but add or change just a few. We can also dynamically extend a small ensemble of classes and objects during run-time operations depending upon the properties of the data and subsystem states. For example, we don't know in advance whether a data object will have a nowcast or historical attribute or an “A” or “B” data stream attribute. Yet, we still want an interface that can interpret these attributes once they are defined so as to decide later on if model inputs are valid for a given application.

An extremely useful software design concept is the ability to allow dynamic modification of a data object's attributes using code developed from a design pattern. A pattern is a generic software template that elegantly addresses typical types of software requirements and that can be tailored to address particular requirements. We employ a design pattern to wrap data objects for transfer between models or system components.

The operational Ionospheric Forecast System has many data objects, models, system components, and even data streams that exist asynchronously or simultaneously. Because of this, time definition is a core attribute and redundancy is a core feature of this system. An abstract design pattern that can manage both the time attribute and redundancy features is an abstract factory design pattern. This is a set of classes that, depending on the current attributes of objects, returns one of several families of subclasses to calling classes. For example, the S2KOP model system uses F10.7 as both an input and an output. In running the model, one set of input objects (historical and nowcast F10.7) will be used that have been “instantiated” (created) and another set of output objects (forecast F10.7) will be instantiated. These run-time classes of F10.7 data objects (“A” stream historical, nowcast, and forecast) are temporarily built from an abstract pattern (template) as soon as they are needed, they exist for some period of time, then disappear when they are no longer needed.

The Builder Design Pattern, which is derived from the Abstract Factory Design Pattern, is an ideal application for the family of data objects we are using in this system. We have selected the Builder Design Pattern as the template for data objects because it cleanly separates the data from model selection or run parameters. We have modified the generic Builder Design and Factory Design patterns to create templates that uniquely implement our own system's flexible and robust qualities.

The modified pattern concepts can be conceived in a UML class diagram where a three-by-three matrix combines the time attribute with the redundancy feature. Time progresses along the vertical axis from the past (bottom) to the future (top) while the data streams that provide redundancy in data availability are separated along the horizontal axis. The “A” (left side) and “B” (right side) data streams are examples of the Builder Design pattern and each has slightly different qualities to describe enhanced or core characteristics, respectively. Both data streams derive from the higher level abstract factory pattern which is shown in the middle column. This matrix template, combining both time and redundancy, is the top level UML framework for all communication software in the operational system linking models with data objects and is shown in Table 8.

The terms “Forecast” vs. “Predicted,” “Nowcast” vs. “Current,” and “Historical” vs. “Previous” are used to distinguish the different builder patterns based on past, present, and future time states. They are all extensions of the same foundation class but represent distinctly different subclass families for the Enhanced (“A”) and Core (“B”) data objects. It is noted in OOP terminology that the word “extends” means an inheritance property (“is-a” type of relationship). For example, a Forecast class is a State Future class and it extends (employs) the methods of the parent level State Future class. The word “uses” is a composition property, i.e., a class can be a composite of other classes (“has-a” type of relationship). For example, a Predicted class has a Current class which has a Previous class.

The design pattern concepts are the fundamental component of data objects and other classes throughout the system design. The TimeStateFactory collection of classes is the implementation of the higher level Factory design pattern. A consequence of the TimeStateFactory pattern is that each client model object will have control of exactly how the model specifies it's data I/O and run parameters. This provides an enormous time-saver for each team member's model developers if they do not have to redefine their data input and output parameters. From a systems point-of-view it also provides a common platform (“suitcase”) for communication between system components. An additional consequence of this TimeStateFactory pattern is that each data stream is independent of the other and embedded data objects are independent of each other. This makes the program very modular and allows for easy addition of new or updated data sets and models.

TABLE 8
Top Level Factory and Builder Design Patterns

| Enhanced | | Foundation | | Core |
|---|---|---|---|---|
| Stream A | | Classes | | Stream B |
| Forecast | extends ---------------> | StateFuture | <--------------- extends | Predicted |
| Nowcast | extends ---------------> | StatePresent | <--------------- extends | Current |
| Historical | extends ---------------> | StatePast | <--------------- extends | Previous |

The TimeStateDriver builder pattern class will be launched by the server every time a new data object is detected. This will create a family of classes based on whether the data refers to the past, present, or future. It does this by binding the TimeStateFactory class to a particular IOobject and this, in turn, extends the DataObj class (see below). The DataObj is the “data suitcase” sent between the server, ODBMS, and clients. Once the TimeStateFactory class instantiates a PastState, PresentState, or FutureState class it, in effect, creates a unique object. For example, the PresentState class would create a NowcastState object for stream “A” by extending the abstract StatePresent class. All of the methods that are specified in the TimeStateFactory such as get_DateTime( ) are available in the newly-formed NowcastState object.

Since the state of the family of classes (FutureState, PresentState, and PastState) refers to the attributes and values of an instantiated data object at a specific time (either Forecast or Predicted, for example, depending on whether it is an A or B data stream object). In operations, the state of specific data sets and related classes will always be updating with new values added or changed as each measurement changes and each model operates asynchronously. There will always be a single current data object which is an instantaneous snapshot of all the data attributes.

4.3.2.5 Data Objects

What do data objects actually look like? Like most other classes and their objects, the DataObj (super) class is composed of a number of other sub-classes. In the Operational Ionospheric Forecast System, the DataObj class includes the scalar, vector, tensor data values for a single data type (termed “vector” here), the version of the last model that modified it, what formats it can use, and self-validating information. Many of the objects are contained within a DataObj class. Integer pairs can be used to indicated how many instances the parent class expects of each object. The use of “0,1” indicates the range of values of either “0” or “1.” For example, a DataObj must contain information on its parent (1) but does not necessarily need a serializer (0,1). There is no more than one instance of a child object with the exception of IOrecords. A vector is created in the IOvector and there can be any number of IOrecords in the vector. There are numerous classes that are used to validate key objects; this design allows any client or server to examine a data object for validity prior to use.

The IOobj subclass contains the IOrecord which has access to all the methods contained within the IOrecord. When an attribute is stored at the IOrecord level, all classes, including the PrimaryServerDaemon class, can make decisions about how to operate on or use the record.

4.3.3 Validation and Verification

4.3.3.1 Forecast Skills and Quality Monitoring

A key element in improving forecast accuracy is to continuously monitor forecast quality. Forecast quality is measured by skill scores and several definitions of forecast skill exist in the meteorological community. We describe one technique below. The system is designed to systematically compute the forecast skill and therefore, provide a quality monitoring capability.

One important quality monitoring method is the ensemble forecast. As described in section 3.5, different forecast results based on different analyses provide an indication of forecast uncertainty. Similarly, perturbation of the ionospheric driving forces can also lead to different forecasts. In the case of initializing the ionospheric model using analyses, the difference in the forecast will usually diminish. However, this does not indicate an increase in forecast certainty but, instead, a lack of data. As a corollary, perturbation of driving forces from the non-GAIM models can lead to increased forecast differences and the design enables the creation of a forecast ensemble that can provide an estimate of forecast uncertainty. In the validation period, the differences between E10.7 and F10.7 used in models can help provide an uncertainty, as an example.

An important part of the future work is to define an appropriate forecast skill. One of the candidates for forecast skill is the Normalized Cross Correlation coefficient defined by:

$$ϕ = \frac{{\sum }_{k = 1}^{N} ( {n}_{k}^{f} - {\overline{n}}^{f} ) \cdot ( {n}_{k}^{a} - {\overline{n}}^{a} )}{\sqrt{{\sum }_{k = 1}^{N} {( {n}_{k}^{f} - {\overline{n}}^{f} )}^{2} \cdot {\sum }_{k = 1}^{N} {( {n}_{k}^{a} - {\overline{n}}^{a} )}^{2}}} \qquad ( 3 )$$

where nₖ^{f} and \overline{n}^{f} are the forecast value at the k-th grid point and mean values over all forecast point. Similarly, nₖ^{a} and \overline{n}^{a} are the analysis values. One problem with the above skill is that if nₖ^{f} represents the ion density there is a great variability in ionospheric ion density. The above skill is dominated by the large ion densities. Alternatively, we can replace nₖ^{f} by rₖ^{f} where

$${r}_{k}^{f} = \frac{{n}_{k}^{f} - {n}_{k}^{c}}{{n}_{k}^{c}} . \qquad ( 4 )$$

The quantity nₖ^{c} is the climatological value for the ion density.

Another problem with skills defined above is that if there are no data available between forecast and analysis times, the forecast skill would be perfect. However, this is a common problem with most of forecast skills. The final definition of forecast skill requires consensus in the ionospheric research community. The system provides a valuable test-bed for forecast skill metrics and this is an area of potential work in our collaboration with NOAA SEC.

It is important to indicate the difference between computation of forecast skill and direct validation of a forecast. In direct validation, we compare a forecast ionospheric quantity to the measured quantity. This provides an absolute measurement on the accuracy of the forecast. However, the difference between the forecast values and the actual measurement includes two types of errors. The first is the analysis error. In this case, the data assimilation provides an analysis of the ionospheric condition based on the modeled physics and the ensemble of all available data. This analysis represents the best physically self-consistent interpretation of the data. The second error is forecast error. The forecast skill attempts to characterize the forecast error. The systematic evaluation of the forecast skill provides us with valuable information about how to improve the accuracy of the forecast.

4.3.3.2 GAIM Accuracy Validation

To forecast the ionospheric state accurately, one must also “nowcast” accurately. The accuracy of GAIM assimilations and the resulting electron density specifications have already been validated in three ways: (1) by a series of simulation experiments in which a known ionospheric density field is used to generate synthetic input data for simulated assimilation runs; (2) by a series of validation case studies using actual input datasets and multiple kinds of validation data; and (3) by continuous validation of daily operational Kalman filter runs beginning in March of 2003.

Simulation. For the simulation experiments, the electron density field and the appropriate values of the drivers (e.g., equatorial E×B vertical drift, neutral winds, and production terms) are known and can be compared to the values estimated by GAIM after input of the synthetic data. For example, we have demonstrated that using only ground GPS TEC links one can gain sufficient information about the shape and location of the equatorial anomaly arcs to estimate E×B vertical drift values as a function of local time and a grid of neutral wind values in geomagnetic coordinates (see Pi et al., 2003 and recent 4DVAR talks available on the GAIM web site).

Validation Cases. For case studies using real input datasets, the true ionospheric state is not known so the accuracy of the electron density specification is evaluated by comparisons to independent ionospheric observations and/or alternative density retrieval techniques. Major validation case studies have been performed for five types or combinations of input data assimilated by GAIM: (1) absolute TEC data from ground GPS receivers (global network); (2) relative TEC data from GPS occultations (flight receivers on IOX, CHAMP, and SAC-C); (3) radiance data from nighttime FUV limb scans (LORAAS instrument on ARGOS); (4) ground GPS TEC combined with GPS occultations; and (5) ground GPS combined with UV limb scans. The combined data runs are particularly relevant to future operational scenarios in which the ground GPS network provides good overall global TEC coverage and dense coverage in some regions, but limited vertical resolution, while GPS occultations from the planned six-satellite COSMIC constellation and UV scans from the SSUSI and SSULI instruments on DMSP provide detailed regional data with excellent vertical resolution.

The accuracy validation studies have included comparisons to: vertical TEC measurements from the TOPEX and JASON dual-frequency ocean altimeters (1330 km altitude); slant TEC measurements from independent GPS sites; FoF2 and HmF2 values or bottom-side profiles from ionosondes; density profiles from incoherent scatter radars; density profiles obtained from Abel inversions of GPS occultations (alternative retrieval technique); and two-dimensional density retrievals (in the plane of the ARGOS satellite orbit) computed by the NRL UV group using Chapman layers. Examples of each of these kinds of validation are documented in the papers and presentations available on the USC/JPL GAIM web site.

Continuous Daily Validation. In order to start accumulating long-term accuracy statistics for GAIM density specification, daily runs of the global Kalman filter began in March of 2003. Each day GAIM assimilates more than 200,000 ground GPS TEC observations from 98+sites to specify the ionospheric density state. The intent is to continuously validate GAIM accuracy as input data types are added (UV radiances or GPS occultations) along with improved drivers from the other operational models. The validation process will be completely automated and performed every day as part of several assimilation runs. Forecast and nowcast accuracy cannot be established by one-time case studies but must be continuously monitored.

Several validation comparisons are already being automated so that accuracy statistics accumulate for every hour and day. They include comparisons to vertical TEC from TOPEX or JASON, to slant TEC from independent GPS sites that probe a variety of latitude and longitude sectors, and to foF2 and HmF2 observations from global ionosonde sites. New JASON data are available every 3-4 hours and the data from independent GPS sites are collected either hourly or daily so accuracy can be monitored every few hours and statistics accumulated daily. The public ionosonde data are delayed but the accuracy of yesterday's ionospheric specification can be evaluated with a 1-day delay along with the skill score for the 24-hour ionospheric forecast.

As an example of the on-going validation, consider a comparison of GAIM results to TOPEX vertical TEC observations on Mar. 12, 2003. There were 98 GPS sites used as input for the assimilation with a daytime TOPEX track passing near Hawaii. To perform the comparison, the GAIM density grid was integrated vertically to predict the vertical TEC at the exact location of each TOPEX observation. The measured TOPEX TEC data were compared with the predicted TEC values from: (1) the GAIM assimilation; (2) the GAIM “climate”; (3) the IRI95 model; and (4) the two-dimensional TEC maps from the JPL GIM model. The GAIM assimilation result followed the two equatorial anomaly peaks as well as the trough between them and the more gradual mid-latitude gradients. The RMS differences for this track are 4.9 TEC units (10¹⁶ el/m²) for the GAIM assimilation versus 11.3 TECU for the GAIM climate and 12.2 TECU for IR195.

By accumulating the differences (GAIM minus vertical TEC measurements) for all of the TOPEX or JASON tracks each day, one can compute a daily RMS error for the low-, mid-, and high-latitude regions. Note that TOPEX and JASON only probe a fixed local time on any given day. From the daily RMS errors for more than half of a year, Mar. 11 to Oct. 17, 2003 for low-latitude (below 30 degrees), mid- and high-latitude observations, the GAIM assimilation accuracy is quantitatively better than the GAIM climate or IR195 with often 3-7 TECU in the low-latitudes and 3-5 TECU in the mid- and high-latitudes. The variation in the error during the period is a combination of several effects including seasonal dependence of the ionosphere (spring and fall ionosphere levels versus summer), quiet versus disturbed days, and the change in the local time probed by TOPEX.

4.3.3.3 Operational Software Validation

We have designed the system to track and maintain information about the current state of the analysis and forecast errors of the physical representation of the ionosphere as described above. We use imbedded validation methods and flags associated with each record and encapsulating objects to do this. In addition, we perform a second type of validation monitoring, i.e., that of the “state of health” of the current operating system. To track the physics representation and operating system indicators, we use a validation daemon. The Validator daemon (a continually running process) is based on a SET-developed design pattern for validating multiple asynchronous processes. Imbedded validation methods and flags provide information such as geophysical limits on input data and current forecast skill so that a process can decide if the data object is valid. The Validator daemon runs a set of processes that monitor the system-level communications and interim data object validation results. The Validator daemon monitors all the input data and model data quality, can detect fatal program errors, and sets metadata flags in each object at their creation which enables subsequent programs to make decisions based on the validation flags. Decisions about which data stream to use or whether or not to notify an operator of a significant problem are also made based on the Validator daemon actions.

The Validator class requires every process to create, update, and close a “Deadman” file during its execution. This file contains diagnostic information and flags describing the run status of every process. As a sidebar, the word “Deadman” was chosen based on the old “Deadman switch” used by train engineers; if the engineer ever let go of the switch, the train would automatically stop. The Deadman classes are conceptual relatives, i.e., if anything goes wrong, a Deadman file exists that contains information to locate the point of failure. The top-level Validator class then uses a “ToeTagger” class to analyze all the existing Deadman files and the ToeTagger information contains the summary status of the entire system's operation. In addition, a unique feature of the system is that the Validator class produces one overall run status flag based on the ensemble of Deadman files and run status flags in the DataObj. If the ToeTagger class and run status flags indicate there are no problems in any of the Deadman files or DataObj, we are guaranteed that all models have been validated. The entire system's current state can be summarized in a single code number, character, or expression.

4.3.3.4 Validation Intent

The design for this system incorporates the validation activities described above to ensure that the data objects meet their specified requirements or fall within acceptable, pre-defined limits during operations. Each model developer provides the limits of validity for input and output data and these are tracked in the appropriate classes. Usually, the values are defined with geophysical limits (minimum and maximum values). Additionally, some data types will be judged in relation to whether or not they are statistically near the expected values (n-sigma, Δt, mean). Other data types will meet a requirement to be statistically equivalent to similar data types (n %, r). The validation class contains, where appropriate, the selection criteria for “better” if two similar data types are compared (comparison scale). The requirements documents detail the format and values of these validation activities and parameters.

4.3.3.5 Verification Intent

Following validation, the system design enables us to determine if the data output objects meet the intent of the requirements. In a daily post-analysis of the GAIM output data (1-2 day lag), for example, we will provide ongoing skill scores comparing forecasts with actual ionospheric parameters. Prior to operations, much of the testing and validation work will provide a baseline for verifying the climatological forecast output of the operational ionospheric forecast system. Verification will primarily be performed with independent data and model comparisons.

4.3.3.6 Testing Intent

A component and system end-to-end test plan will be developed. We will also identify metrics for evaluating system performance and for validation and verification of output product accuracy, precision, and error. Comparative independent data will be reviewed and collected to aid with the system's evaluation while use-case scenarios will be evaluated to test for operational anomalies. A strategy for modular validation, verification, and self-testing of upgraded elements, once the system is operational, is being developed.

4.3.3.7 Team Practices

Our team uses best engineering practices consistent with Capability Maturity Model (CMM) Level 2 processes to meet operational requirements. As the lead organization, SET's engineering practices have proven successful in four research model-to-operations transitions since the mid 1990's: (1,2) the Magnetospheric Specification Model (MSM) and the SOLAR2000 models implemented at NOAA SEC in Boulder; (3) the proprietary SET commercial server; and (4) the USAF HASDM project.

4.3.4 Upgrades, Maintenance Strategy

Our team is developing an upgrade and system maintenance design strategy. The implementation strategy uses modular validation, verification, and testing of upgraded system elements once the system is declared operational. When models are modular units that can be upgraded or replaced, then the upgrade framework can take advantage of new technology, advanced physics, and extended collaborations. Modularity allows upgrades to occur easily on a component by component basis. This guideline lays the foundation for long-term system and product evolution.

4.3.5 Risk Management

During any portion of project life cycle, risks emerge that can significantly affect the system or software design. We use Technology Readiness Level (TRL) definitions as the highest level risk management tool for ensuring a successful life cycle. It describes the life cycle of a project going from initial concept to successful operational implementation. Many projects can have a very long TRL lifetime (years) from low- to high-TRL levels. In the worst case, a risk area with a low-TRL level has the potential of making it impossible to complete the project with the financial resources available. We begin the life cycle risk management with models that are at mid-TRL levels and data streams that are at high-TRL levels. The demonstration for this system proceeds from TRL 6 to TRL 8 while TRL 9 represents a final implementation activity. Table 9 summarizes the top level critical risk areas, their primary concerns, and their mitigation strategies.

4.3.6 Safety

The system uses COTS software and hardware systems. Each institution maintains its own safety program as appropriate to its circumstances. There are no extraordinary safety issues associated with the software development and network connectivity for the system. We use a Class A commercial server facility for hosting the system with its own security and safety procedures.

TABLE 9
Critical Risks and Mitigation

| Critical risk areas and concerns | Mitigation strategy |
|---|---|
| Scientific validity and quality | |
| 1) geophysically valid | 1) validation tests conducted |
| parameters | in future; highly time variable |
| | parameters (particle fluxes, Dst, |
| | Ap, B, w, for example) may be |
| | less reliable and we will improve |
| | some of them in the Enhancement |
| | Program |
| 2) accurate and precise | 2) validation tests can be built |
| parameters | into the software to permit |
| | automated alternate actions in |
| | the event of exceptions to normal |
| | operations |
| 3) incorporation of new | 3) model modularity enables new |
| physics | physics insertion |
| System forecast operations | |
| 1) single points of failure | 1a) design two streams “A” |
| | and “B” for dual redundancy; |
| | models linkage is through an |
| | independent data base with dynamic |
| | input and output of data resources; |
| | models run asynchronously at their |
| | native cadence, execution time, |
| | and environment |
| | 1b) develop a network switch to |
| | guarantee operational robustness |
| 2) component failures, | 2) design two streams “A” |
| data dropouts, latency, | and “B” for dual redundancy; |
| concurrency | use model climatology in the event |
| | of dropouts, latency; embody |
| | graceful degradation; stream |
| | “B” is always available, |
| | either measured or modeled |
| 3) complexity of operations | 3) track, log, and report on the |
| and network | operational state of the entire |
| | system with validator daemon; |
| | maintain knowledge of the overall |
| | operational state and network |
| | communications; summarize system |
| | state with code value |
| Software reliability | |
| 1) data object JIT transfer | 1) four-tier data communication |
| | system architecture for transfer |
| | of input/output data objects |
| | enables continuous availability |
| 2) data stream outages or | 2) dual data stream, dual models |
| delays from model failures, | or data sets, central and backup |
| data concurrency and latency, | computers |
| computer and network | |
| communication failures | |
| 3) software development | 3) unit and end-to-end system |
| failures | testing and validation using |
| | proven software |
| 4) maintenance failures | 4) validator daemon process |
| | captures and reports exceptions |
| 5) operational upgrade | 5) testing for operational |
| failures | upgrades on backup machines |
| Hardware robustness | |
| 1) central client server, | 1) central and backup computers |
| compute engine, or DBMS | |
| computer failure | |
| 2) external environment to | 2) central and backup computers |
| operational system has network | physically separated; use dedi- |
| outages and power failures | cated communication lines |
| Project management | |
| 1) maintain geographically | 1) hold team teleconferences on |
| separated team with diverse | regular basis, conduct site visits |
| members from different | and face-to-face meetings as |
| institutional cultures | necessary; use prime contractor |
| | and subcontractor funding |
| | relationship |
| Financial | |
| 1) funding “valley of death” | 1) start with data streams at |
| moving from low to high TRL | TRL 8 or 9 and models at TRL 6 |
| levels | or higher |
| 2) satisfy diverse institu- | 2) negotiate IP and license |
| tional funding and intellec- | agreements early in project |
| tual property requirements | |
| Schedule | |
| 1) incorporate diverse data | 1) start at mid or high TRL levels |
| sets, models, and hardware/ | for models and data; use COTS |
| software systems in a coor- | software for all major software |
| dinated project to achieve | components and well-proven |
| TRL 8 level by the project | hardware systems that require |
| completion date | minimal system administration |
| Commercialization | |
| 1) identify strategic partners | 1) start strategic partner |
| to achieve contracts with | discussions for effective |
| identifiable customers for | relationships |
| specific product deliveries | |

### REFERENCES

Akasofu, S.-I., in Space Weather, eds. P. Song, H. J. Singer, and G. L. Siscoe, AGU Geophysical Monograph 125, American Geophysical Union, Washington, D.C., p. 329, 2001.
Arge, C. N. and V. J. Pizzo, Improvement in the prediction of solar wind conditions using near-real-time solar magnetic field updates, J. Geophys. Res., 105, 10,465, 2000.
Bailey, G. J., R. Sellek, and Y. Rippeth, Ann. Geophys., 11, 263, 1993.
Booch, Grady, Object-Oriented Analysis and Design with Applications, Addison-Wesley Object Technology Series, Benjamin/Cummings, 1994.
Burton, R. K., R. L. McPherron, and C. T. Russell, An empirical relationship between interplanetary conditions and Dst, J. Geophys. Res., 80 (31), 4204, 1975.
Chun, F. K., D. J. Knipp, M. G. McHarg, G. Lu, B. A. Emery, S. Vennerstrom, and O. A. Troshichev, Geophys. Res. Lett., 26 (8), 1101, 1999.
Dryer, M., Interplanetary studies: Propagation of disturbances between the Sun and magnetosphere, Space Sci. Rev., 67, 363, 1994.
Dryer, M., Multi-dimensional MHD simulation of solar-generated disturbances: Space weather forecasting of geomagnetic storms, AIAA J., 36, 23,717, 1998.
Fry, C. D., The Three-Dimensional Geometry of the Heliosphere: Quiet Time and Disturbed Periods, Ph.D. dissertation, University of Alaska, Fairbanks, 1985.
Fry, C. D., W. Sun, C. Deehr, M. Dryer, Z. Smith, S.-I. Akasofu, M. Tokumaru, and M. Kojima, J. Geophys. Res., 106, 20,985, 2001.
Fry, C. D., M. Dryer, C. S. Deehr, W. Sun, S.-I. Akasofu, and Z. Smith, “Forecasting solar wind structures and shock arrival times using an ensemble of models,” J. Geophys. Res., 108, 10.1029/2002JA009474, 2003.
Fuller-Rowell, T. J., and D. S. Evans, Height-integrated Pedersen and Hall conductivity patterns inferred from the TIROS-NOAA satellite data, J. Geophys. Res., 92, 7606, 1987.
Hajj, G. A., B. D. Wilson, C. Wang, X. Pi, I. G. Rosen, Ionospheric Data Assimilation of Ground GPS TEC by Use of the Kalman Filter, to appear in Radio Science, 2003.
Hakamada, K., and S.-I. Akasofu, Simulation of three-dimensional solar wind disturbances and resulting geomagnetic storms, Space Sci. Rev., 31, 3, 1982.
Hedin, A. E., M. J. Buonsanto, M. Codrescu, M.-L. Duboin, C. G. Fesen, M. E. Hagan, K. L. Miller, and D. P. Sipler, J. Geophys. Res., 99, 17,601, 1994.
Hedin, A. E., E. L. Fleming, A. H. Manson, F. J. Schmidlin, S. K. Avery, R. R. Clark, S. J. Franke, G. J. Fraser, T. Tsuda, F. Vial, and R. A. Vincent, J. Atmos. Terr. Phys., 58, 1421, 1996.
Heppner, J. P. and N. C. Maynard, Empirical high-latitude electric field models, J. Geophys. Res., 92 (A5), 4467, 1987.
Knipp, D. J, T. Welliver, M. G. McHarg, F. K. Chun, W. K. Tobiska, and D. Evans, Adv. Space Research, in press, 2004.
McPherron, R. L., Predicting the Ap index from past behavior and solar wind velocity, Phys. Chem. Earth, 24 (1-3), 45, 1998.
McPherron, R. L., and T. P. O'Brien, Predicting Geomagnetic Activity: The Dst Index, in Space Weather, edited by P. Song, G. L. Siscoe, and H. Singer, American Geophysical Union, Clearwater, Fla., p. 339, 2001.
National Space Weather Program Implementation Plan, 2nd Edition, FCM-P31-2000, Washington, July 2000.
O'Brien, T. P. and R. L. McPherron, J. Atm. Solar Terr. Phys., 62, 14, 1295, 2000a.
O'Brien, T. P., and R. L. McPherron, An empirical phase-space analysis of ring current dynamics: solar wind control of injection and decay, J. Geophys. Res., 105 (A4), 7707, 2000b.
O'Brien, T. P., and R. L. McPherron, Seasonal and diurnal variation of Dst dynamics, J. Geophys. Res., 107 A11), doi:10.1029/2002JA009435, SMP 3-1, 2002.
Papitashvili, V. O., B. A. Belov, D. S. Faermark, Ya. I. Feldstein, S. A. Golyshev, L. I. Gromova, and A. E. Levitin, Electric potential patterns in the Northern and Southern polar regions parameterized by the interplanetary magnetic field, J. Geophys. Res., 99 (A7), 13,251, 1994.
Papitashvili, V. O., C. R. Clauer, T. L. Killeen, B. A. Belov, S. A. Golyshev, and A. E. Levitin, Adv. Space Res., 22, No. 1, 113, 1998.
Papitashvili, V. O., F. J. Rich, M. A. Heinemann, and M. R. Hairston, J. Geophys. Res., 104, No. A1, 177, 1999.
Papitashvili, V. O., and F. J. Rich, J. Geophys. Res., 107, A8, SIA 17, 1, 2002.
Pi, X., G. A. Hajj, I. G. Rosen, C. Wang, and B. D. Wilson, The Semiannual MURI Review, January, Boulder, Colo., 2001.
Pi, X., C. Wang, G. A. Hajj, G. Rosen, B. D. Wilson, and G. J. Bailey, Estimation of E×B Drift Using a Global Assimilative Ionospheric Model: An Observation System Simulation Experiment, J. Geophys. Res., 180 (A2), 1075, doi:10.1029/2001JA009235, 2003.
Raben, V. J., D. S. Evans, H. H. Sauer, S. R. Sahm, and M. Huynh, TIROS/NOAA satellite space environment monitor data archive documentation: 1995 update, NOAA Technical Memorandum ERL SEL-86, Environmental Research Laboratories, Boulder, Colo., 1995.
Richmond, A. D. and Y. Kamide, J. Geophys. Res., 93, 5741, 1988.
Scherliess L, Fejer B. G., Radar and satellite global equatorial F region vertical drift model, J. Geophys. Res, 104 (A4), 6829, 1999.
Sharber, J. R., R. A. Frahm, M. P. Wüest, G. Crowley, and J. K. Jennings, Empirical Modeling of Global Energy Input During the April. 2002 Storms, presented at AGU Fall Meeting, abstract SM32B-1157, EOS Fall Meeting Supplement p. F1286, 2003.
Sinan, A. S., UML in a Nutshell, O'Reilly & Associates, Inc., 1998.
Sun, W., S.-I. Akasofu, Z. K. Smith, and M. Dryer, Calibration of the kinematic method of studying the solar wind on the basis of a one-dimensional MHD solution and a simulation study of the heliosphere between Nov. 22-Dec. 6, 1977, Planet. Space Sci., 33, 933, 1985.
Svalgaard, L., Geomagnetic activity: Dependence on solar wind parameters, in Coronal Holes and High Speed Wind Streams, edited by J. B. Zirker, Colorado Assoc. Univ. Press, Boulder, Colo., 1977.
Temerin, M., and L. Xinlin, A new model for the prediction of Dst on the basis of the solar wind, J. Geophys. Res., 107 (A12), 1472, doi:10.1029/2001JA007532, 2002.
Tobiska, W. K., A Solar Extreme Ultraviolet Flux Model, Ph.D. Thesis, Department of Aerospace Engineering, University of Colorado, 1988.
Tobiska, W. K., J. Geophys. Res., 106, A12, 29,969, 2001.
Tobiska, W. K., J. Spacecraft Rock., 40, 405, 2003.
Tobiska, W. K. in 4^{th} (Virtual) Thermospheric/Ionospheric Geospheric Research (TIGER) Symposium, http://www.ipm.fraunhofer.de/english/meetings/workshops/tiger/ Jun. 10-14, 2002.
Tobiska, W. K., T. Woods, F. Eparvier, R. Viereck, L. Floyd, D. Bouwer, G. Rottman, and O. R. White, J. Atm. Solar Terr. Phys., 62, 14, 1233, 2000.
Troshichev, O. A., V. G. Andersen, S. Vennerstrom, and E. Friis-Christensen, Planet. Space Sci., 36, 1095, 1988.
Viereck, R., L. Puga, D. McMullin, D. Judge, M. Weber, and W. K. Tobiska, Geophys. Res. Lett., 28, 1343, 2001.
Wang, C., G. A. Hajj, X. Pi, 1. G. Rosen, B. D. Wilson, A Review of the Development of a Global Assimilative Ionospheric Model, to appear in Radio Science, 2003.
Wang, Y.-M. and N. R. Sheeley, Solar wind speed and coronal flux-tube expansion, Astrophys. J., 355, 726, 1990.
Weimer, D. R., Models of high-latitude electric potentials derived with a least error fit of spherical harmonic coefficients, J. Geophys. Res., 100 (A10), 19,595, 1995.
Weimer, D. R., D. M. Ober, N. C. Maynard, M. R. Collier, D. J. McComas, N. F. Ness, C. W. Smith, and J. Watermann, Predicting interplanetary magnetic field (IMF) propagation delay times using the minimum variance technique, J. Geophys. Res., 108 (A1), SMP 16-1, doi:10.1029/2002JA009405, 2003.
Wüest, M., R. A. Frahm, J. K. Jennings, and J. R. Sharber, in 4^{th} (Virtual) Thermospheric/Ionospheric Geospheric Research (TIGER) Symposium, http://www.ipm.fraunhofer.de/english/meetings/workshops/tiger/ Jun. 10-14, 2002.
Wüest, M., R. A. Frahm, J. K. Jennings, and J. R. Sharber, Forecasting electron precipitation based on predicted geomagnetic activity, Adv. Space Res., in press, accepted for publication, December, 2003.
   Glossary
   Space Environment Definitions
   AU. AU (or ua) designates an Astronomical Unit (AU) and is a unit of length approximately equal to the mean distance between the Sun and Earth with a currently accepted value of (149 597 870 691±3) m. Distances between objects within the solar system are frequently expressed in terms of AU. The AU is a non-SI unit accepted for use with the International System and whose value in SI units is obtained experimentally. Its value is such that, when used to describe the motion of bodies in the solar system, the heliocentric gravitation constant is (0.017 202 098 95)² ua³ d⁻² where one day, d, is 86 400 s. One AU is slightly less than the average distance between the Earth and the Sun since an AU is based on the radius of a Keplerian circular orbit of a point-mass having an orbital period in days of 2π/k (k is the Gaussian gravitational constant and is (0.01720209895 AU³ d⁻²)^{1/2}). The most current published authoritative source for the value of 1 AU is from the Jet Propulsion Laboratory (JPL) Planetary and Lunar Ephemerides, DE405/LE405.
   National Space Weather Program. The National Space Weather Program (NSWP) Implementation Plan (IP), second edition (FCM-P31-2000) published in July 2000 and accessible at http://www.ofcm.gov/, describes the goal to improve our understanding of space weather effects upon terrestrial systems. Operationally characterizing space weather as a coupled, seamless system from the Sun to Earth is one achievement of this goal. Among the areas of interest for improved understanding are the space weather processes affecting the thermosphere and ionosphere.
   Solar Irradiance. The Sun's radiation integrated over the full disk and expressed as in SI units of power through a unit of area, W m⁻². The commonly used term “full disk” includes all of the Sun's irradiance coming from the solar photosphere and temperature regimes at higher altitudes, including the chromosphere, transition region, and corona. Some users refer to these composite irradiances as “whole Sun.” Solar irradiance is more precisely synonymous with “total solar irradiance” while spectral solar irradiance is the derivative of irradiance with respect to wavelength and can be expressed in SI units of W m⁻³; an acceptable SI submultiple unit description can be W m⁻² nm⁻¹.
   Space Weather. The shorter-term variable impact of the Sun's photons, solar wind particles, and interplanetary magnetic field upon the Earth's environment that can adversely affect our technological systems is colloquially known as space weather. It includes, for example, the effects of solar coronal mass ejections, solar flares, solar and galactic energetic particles, as well as the solar wind, all of which affect Earth's magnetospheric particles and fields, geomagnetic and electrodynamical conditions, radiation belts, aurorae, ionosphere, and the neutral thermosphere and mesosphere during perturbed as well as quiet levels of solar activity.
      SOLAR2000 Definitions
   als. als is the MFD bulletin 1-sigma uncertainty of a3h in Ap units.
   a3h. a3h is the MFD bulletin 3-hour average value of the Ap forecast to 72 hours in Ap units.
   Ap. Ap is the daily mean value of the planetary geomagnetic index in units of 2 nanoTesla (nT). Ap is the 3-hour value of the planetary geomagnetic index.
   B3h. B3h is the MFD bulletin 3-hour average value of the E81 forecast to 72 hours in E10 units.
   E1_{—}40. E1_{—}40 is the daily value of the integrated EUV energy flux between 1-40 nm in units of ergs per centimeter squared per second.
   E10. E10 is the daily value of the integrated solar extreme ultraviolet (EUV) energy flux from 1-105 nm at the top of the atmosphere and reported in F10 units. It represents the spectral solar energy available for photoabsorption and photoionization that is separately input into numerical models. Normal practice is to refer to the value as “E10.7” but E10 is used here as an abbreviation.
   E1s. Els is the MFD bulletin 1-sigma uncertainty of E3h in E10 units.
   E3h. E3h is the MFD bulletin 3-hour average value of the E10 forecast to 72 hours in E10 units.
   E81. E81 is the daily value of the 81-day running average of the E10 centered at the current epoch (date) and in the E10 units.
   Forecast. Forecast irradiances and integrated irradiance proxies are provided for government and commercial customers. The SOLAR2000 PG, OP, and SY models current (and first) generation forecast algorithm is denoted FGen 1× and relies on linear predictive techniques. The fundamental assumption of persistence in solar irradiances at time scales of interest (3-days, 14-days, 28-days, 4-months, 1 solar cycle, and 5 solar cycles) is the basis for these techniques. FGen 2 will provide forecast irradiances on the same timescales based on physics, measurements, and mathematical tools.
   F10. F10.7 is the daily value of the 10.7-cm solar radio emission measured by the Canadian National Research Council Dominion Radio Astrophysical Observatory at Penticton, BC, Canada. The “observed” value is the number measured by the solar radio telescope at the observatory, is modulated the level of solar activity and the changing distance between the Earth and Sun, and is the quantity to use when terrestrial phenomena are being studied. When the Sun is being studied, it is useful to remove the annual modulation of F10 by the changing Earth-Sun distance and the “1 AU adjusted” value is corrected for variations in the Earth-Sun distance, giving the average distance. Penticton measures the F10, NOAA/SEC reports the F10, and numerous organizations, including SET, forecast the F10. Its units are solar flux units (sfu) or ×10⁻²² Watts per meter squared per Hertz. Normal practice is to refer to the value as “F10.7” but F10 is used here as an abbreviation.
   F81. F81 is the daily value of the 81-day running average of the F10 centered at the current epoch (date) and in the F10 units.
   High Time Resolution. In FGen 1×, the forecasts for next 72-hours are produced on a 3-hour cadence and synchronized with the release of the NOAA/SEC and U.S. Air Force Kp and ap geomagnetic indices.
   Historical. SOLAR2000 daily irradiances and integrated irradiance proxies are provided for all applications from research to operational systems starting from Feb. 14, 1947 through 24 hours prior to the current date.
   Integrated Solar Irradiance Proxies. With the release of SOLAR2000 v2.21, there are a total of seven integrated flux irradiance proxies that are produced for the benefit of specific user communities. These proxies are provided in addition to the three spectral irradiance wavelength formats of 1 m bins for the full spectrum from 1-1,000,000 nm, 39 EUV wavelength groups/lines from 1-105 nm, and 867 EUV lines from 1-122 nm. Each wavelength format is reported in three flux formats of energy (ergs per centimeter squared per second), photon (photons per centimeter squared per second), and SI units (Watts per meter squared).
   L81. L81 is the daily value of the 81-day running average of the Lya centered at the current epoch (date) and in the Lya units.
   Lya. Lya is the daily value of the solar hydrogen atom emission of Lyman-alpha irradiance at 121.67 nm measured from outside the atmosphere and reported in photon flux of ×10⁹ photons per centimeter squared per second.
   Nowcast. SOLAR2000 nowcast irradiances and integrated irradiance proxies, using the operational NOAA 16 SBUV Mg II data for the chromospheric proxy and the 20 UT observed F10 for the coronal proxy, are provided hourly by the SOLAR2000 Operational Grade model located at NOAA Space Environment Center (SEC) in Boulder, Colo. (http://sec.noaa.gov/spacewx/) and by the SET proprietary server (http://SpaceWx.com/). The model is run independently and hourly at both sites. Although the information content changes only twice per day in 2004 using the daily 20 UT F10 and the daily Mg II (NOAA 16), or a few times per day (NOAA 16 combined with NOAA 17 starting in late 2004), the cadence will significantly increase with the inclusion of 5-minute data using the GOES-N EUV broadband detector data after 2005. After that time, the F10 and Mg II will be retained as redundant input proxy data to ensure a capability of calculating the irradiances. At that time, the GOES-N data, absolutely calibrated to the TIMED/SEE instrument data, will become the primary data set for the EUV part of the spectrum. The Mg II will still remain the primary data set for calculating the FUV irradiances after 2005. In addition to graphical representations of the irradiances located at the web sites above, nowcast data files are located and updated with the same hourly cadence at SEC's anonymous FTP server: http://sec.noaa.gov/ftpmenu/lists/spacewx.html.

The files located at that site of “E10.7 nowcast data,” “Solar spectral data,” and “Validation of today's E10.7 data” provide the nowcast E10 with +1-sigma values, the full solar spectrum at 1 nm resolution, and nowcast data of F10, F81, Lya, L81, E10, E81, and S.

The definition of nowcast has evolved in current operations to indicate the period of time between −24 hours to the current epoch (time). Starting 24 hours in the past, the input parameters required for model runs, i.e., the F10 and Mg II data, are already operationally issued and will not change. However, at the current epoch, or “0” hour, the solar conditions will have changed slightly and new information has not yet been received to precisely define what the new proxy values are. Hence, an estimate made of the current conditions and the interpolation from known to unknown conditions during the past 24-hours constitutes a nowcast.

OP. The SOLAR2000 Operational Grade model provides daily historical, hourly nowcast, 72-hour (3-hour interval) and daily forecast data from the SET proprietary operational server.

Regular and continuous upgrades to SOLAR2000 are occurring during the first half of the decade starting in 2000. These upgrades include additional spectral range variability (FUV, UV, VIS, IR), enhanced accuracy with the inclusion of new datasets and improved proxy regression algorithms, improved specification of the uncertainty in the irradiances, the development of nowcast and forecast irradiances along with the historical representations, and the development of new integrated irradiance proxies for user communities. The model has undergone 22 formal releases since Oct. 7, 1999 (v0.10) and Feb. 11, 2004 (v2.23) through the publicly released SOLAR2000 Research Grade model.

SOLAR2000 v2.23 is variable in the XUV/EUV/FUV/UV part of the spectrum. Upgrades in progress include v3.00 VIS/IR variability and v4.00 physics-based model variability. The versioning convention of x.yz for SOLAR2000 upgrade releases is the following.

x: variability of the model's spectral range
1: empirical XUV/EUV (1-122 nm);
2: empirical XUV-UV (1-420 nm);
3: hybrid XUV-IR (1-2000 nm); and
4: hybrid empirical and physics-based (1-1,000,000 nm).
y: data improvement
0: original 12 rocket observations (AFGL f74113, sc21refw, f79050n, f79226, f79314; USC 82222, 83228, 88298, SERTS_{—}96; LASP nov_{—}1988, 1992, 1993, 1994), 1 reference spectrum (ASTM E-490), 4 satellite datasets (SOLRAD, AEE monochromators, YOHKOH/SXT, SOHO/CDS), and 3 theoretical spectra (Avrett);
1: SOHO (SUMER, SEM, CDS accuracy in solar minimum short wavelengths);
2: SNOE, TIMED (SEE) and SDO (EVE) (accuracy in all spectra <200);
3: UARS, TIM, and SIM (UV, VIS, IR accuracy);
4: ISS(SOL-ACES, SOLSPEC, TSI) (solar cycle upgrade to full spectrum); and
5: GOES EUV and POES UV/VIS data (minutely time resolution).
z: code improvement and bug fixes

0-9: new features, algorithm, and code improvements;
a: minor bug fixes; and
b: internal beta test version.
Peuv. Peuv is the daily value of the EUV hemispheric power in units of Watts and is complementary to the auroral hemispheric power index. It is designed for science research and operations use. It is derived from the solar EUV energy flux summed across all wavelengths from 1-105 nm. This value is approximately 6 ergs per centimeter squared per second for an average level of solar activity. This solar energy is assumed to be input across the disk of Earth and is reported in units of GigaWatts (GW). The Peuv heating is greater than auroral hemispheric power except during storm periods.
PG. The SOLAR2000 Professional Grade model provides daily historical through current epoch to forecast data in addition to analysis tools through a platform-independent IDL application. See also discussion in OP section.
Qeuv. Qeuv is the daily value of the thermospheric heating rate derived from an analysis of the time-dependent solar heating of the thermosphere as a function of EUV energy by wavelength, altitudinal heating efficiency, unit optical depth, absorption cross section of each neutral species, and density of each species. These combined quantities are the constituent volume-heating rate in the thermosphere and are integrated across all species, wavelengths, and altitudes for a unit of time to become the derived total thermospheric heating rate in ergs per centimeter squared per second. A third degree polynomial fit is made between the total heating rate and E10.7 for several years over a solar cycle and this is the Qeuv.
RG. The SOLAR2000 Research Grade model provides daily historical to near current epoch data through a platform-independent IDL GUI application. See also discussion in OP section.
Rsn. Rsn is the daily value of the derived sunspot number for use in ray-trace algorithms that historically use the Wolf sunspot number, Rz. Rsn is dimensionless and is derived from a third degree polynomial fit between Rz and E10.7 for several years over a solar cycle. Rsn differs from Rz during solar maximum conditions and does not reach the highest values of Rz. We believe it provides a capability for more accurately representing the variations in the ionosphere that come directly from solar EUV photoionization.
S(t). S(t) or S_C is the daily value of the integrated solar spectrum in units of Watts per meter squared and is provided to users who require the integrated spectrum variability. In early versions of the SOLAR2000 model (v1.yz), the variability comes from the solar spectrum between 1-122 nm (EUV variability). Longwards of 122 nm in the v1.yz model, the ASTM E490 solar reference spectrum is used. Hence, the current variability in S is not the same as the total solar irradiance (TSI). In upgrades beyond v1.yz of SOLAR2000, time-varying spectral models are included to represent the ultraviolet, visible/infrared, and theoretical spectral variability in versions 2.yz, 3.yz, and 4.yz, respectively. In v3.yz, this spectrum will be extremely useful for space systems' users who require an operational, variable integrated solar spectrum for solar radiation pressure calculations on spacecraft. In v4.yz, a high spectral resolution of the Sun's irradiances will be provided for use in satellite imagery calibration.
SRC. SRC is the MFD bulletin data source designation (Issued, Nowcast, Predicted).
SY. The SOLAR2000 System Grade model provides historical, nowcast, forecast data in all time resolutions as a turn-key system at a user-specified location. See also discussion in OP section.
Tinf. Tinf is the daily value of the Earth exospheric temperature at 450 km in units of Kelvin (K). It was developed using a first-principles thermospheric model and is useful for long-term studies to investigate potential anthropogenic climate change effects (cooling) in the thermosphere and subsequent changes to the ionospheric E and F2 layer heights. Tinf is derived from a third degree polynomial fit between the first principles derived exospheric temperature and E10.7 for several years over a solar cycle.
   Java Programming Definitions
Attribute. The name and value of a data value or instance within an object. Objects can contain other objects which are an attribute.
Capability Maturity Model. (CMM) Industry-standard criteria to measure the development practices and capabilities of an organization.
Class. An abstract or general object that will define specific objects. A Java class is the software program stored as a file. The terms class and object are frequently used interchangeably.
Data-Base Management System. (DBMS) An application, e.g., MySQL, Oracle, SQLserver, for maintaining a database.
Graphic User Interface. (GUI) The graphical interface application displayed on the computer monitor that allows the end-user to interact with the underlying program and data.
Method. A method is conceptually similar to a subroutine in that it is a unique set of instructions within a class. Methods are contained within objects.
Object State or Instance. The current attributes (data values) within an object define the object state. Objects are instantiated from classes.
Object. An object is a particular instance of a class that is created when a program begins to run. The terms class and object are frequently used interchangeably.
Object-Oriented Programming. Object-Oriented Programming (OOP) is programming software using Object-Oriented (O) languages such as Java, C++, and Smalltalk as opposed to Fortran, C, and Basic. Object-oriented technology encompasses the principles of abstraction, encapsulation, and modularity. It is fundamentally different from procedural or structured design concepts and can dramatically reduce the costs of software development and maintenance.

Procedural computer languages are “data-centric,” whereas Object-oriented (O) languages are “method-centric.” At first glance, one may think of a data variable or subroutine in Fortran as a object or method in Java but that is a gross over-simplification. In Fortran a main program defines data arrays and parameters and passes these data to subroutines that perform a sequence operation like “if-then-else” or mathematical transformations using a “top-down” set of instructions. Each subroutine tends to be very specific to the data type, e.g., float, integer, passedin, and returned—as parameters. For example, a subroutine will be invoked as CALL CONVERT(Ain, Bin, Cout, Dout) where the parameters (Ain to Cout) will be simple numbers.

OO computer languages (Java is a default standard for OO software) define objects having general methods that replace subroutines and create an abstract view of the data properties. Instead of using only data types such as real numbers, Java defines other objects, e.g., F107_measurement, and uses methods such as A_measurement=getMeasurement (Today). The F10.7 object will have it's own data attributes such as measurementTime or missingvalueDesignator and methods such as validate( ) or returnMeasurement (today). The Today object will also have attributes where today is a SQL string, a Julian day, or a Gregorian day.

By defining a system as a loosely-coupled composite of objects, the details of any object such as how a F10.7 date, for example, is converted to Julian Day are completely hidden by any other object that uses the F107_measurement object. Data attributes and methods of the data properties are encapsulated, making the software very modular. Each object can be a miniprogram in itself which greatly improves unit tests independent of the overall program. An object can also be simply used within another object as a “data variable” that will have its own “subroutines.”

A simple analogy is how a Java program would describe an automobile. It would define the most general automobile object first. It would say it has four wheels, an engine, brakes, etc. It would say it can go and stop. It would not matter whether it was a Chevy or Ford. When a description of a Chevy V-8 is needed, the Chevy object would use the general automobile object, but would additionally add the specifics of the V-8 engine. Nothing else need change since the automobile object still has 4 wheels and will stop or go. Imagine describing an automobile in Fortran!
Object-Oriented. Object-oriented (OO) means defining systems and software using classes and objects with attributes and methods as opposed to procedural parameters and subroutines.
Structured Query Language. (SQL) This is a standardized command language syntax that is used to access a relational DBMS.
System Development Life Cycle. (SDLC) The phases of a system development effort, from the concept of operations and requirements analysis to the stages of unit development and maintenance, can be described as a System Development Life Cycle.
Unified Modeling Language. (UML) This is the 00 version of a flowchart and is a graphical representation that describes the components of an 00 software program.
Validation. Validation means ensuring the software or data meets specified requirements or falls within acceptable limits. Validation is followed by Verification.
Verification. Verification means determining whether or not the software or process meets the intent of the requirements. Verification is preceded by Validation.
   Technology Readiness Level (TRL) Definitions

Technology Readiness Level (TRL) definitions include the topical areas of:
(1) Hardware—any piece of physical equipment that is part of a technology under consideration, e.g., hardware component or model;
(2) Model—the complete description of the performance and cost of a technology, including simulation models;
(3) Test Environment—parameters of a demonstration or test that provide data to define the TRL, e.g., simulation/test of a component or integrated system;
(4) Products—data that are available from the activity defining the TRL ranging from analytical calculations through ground/flight demonstrations;
(5) Uncertainty—an assessment of the demonstration data products that relate any uncertainties in a technology model to the risk of system integration;
(6) Transition Readiness—judgment of how ready the technology is for incorporation into the development phase of a system application; and
(7) Risk—judgment of probability and consequence of failure to a system.
TRL 1. Basic principles observed. Transition from scientific research to applied research. Essential characteristics and behaviors of systems and architectures. Descriptive tools are mathematical formulations or algorithms.
TRL 2. Technology concept formulated. Applied research. Theory and scientific principles are focused on specific application area to define the concept. Characteristics of the application are described. Analytical tools are developed for simulation or analysis of the application.
TRL 3. Analytical proof-of-concept. Proof of concept validation. Active Research and Development (R&D) is initiated with analytical and laboratory studies. Demonstration of technical feasibility using breadboard implementations that are exercised with representative data.
TRL 4. Component, subsystem validation in lab environment. Standalone prototyping implementation and test. Integration of technology elements. Experiments with full-scale problems or data sets.
TRL 5. System, subsystem, component validation in relevant environment. Thorough testing of prototyping in representative environment. Basic technology elements integrated with reasonably realistic supporting elements. Prototyping implementations conform to target environment and interfaces.
TRL 6. System, subsystem, model, prototype demonstrated in relevant environment. Prototyping implementations on full-scale realistic problems. Partially integrated with existing systems. Limited documentation available. Engineering feasibility fully demonstrated in actual system application.
TRL 7. System prototype demonstration in relevant environment. System prototyping demonstration in operational environment. System is at or near scale of the operational system, with most functions available for demonstration and test. Well integrated with collateral and ancillary systems. Limited documentation available.
TRL 8. System completed, tested, and demonstration qualified. End of system development. Fully integrated with operational hardware, software systems. Most user documentation, training documentation, maintenance documentation completed. All functionality tested in operational scenarios. Verification and Validation (V & V) completed.
TRL 9. System operations. Fully integrated with operational hardware/software systems. Actual system has been thoroughly demonstrated and tested in its operational environment. All documentation completed. Successful operational experience. Sustaining engineering support in place.

We claim:

1. the geophysical basis for IFS, i.e., the intellectual construct of the logical flow of modularized information, via space physics models and data streams, that form the IFS system as described in section 3.2;

2. the time domain definition, i.e., the intellectual construct that organizes time into operationally useful domains based on historical, nowcast, and forecast primary data and previous, current, and predicted secondary data as described in section 3.3;

3. the model and data dependencies, i.e., the intellectual construct of the interconnected, dependent flow of information between models and data streams as described in section 3.4 as well as listed in Tables 1, 2, and 3;

4. the operational ionosphere forecast system architectural concept, i.e., the intellectual construct of primary and secondary information flow configured in either a distributed network or as a turnkey, rack-mount system as described in section 3.4;

5. the operational ionosphere forecast system implementation, i.e., the intellectual construct of how the two architectural approaches for IFS are related as described in section 4.3, and specifically including
a. the distributed network system concept of operations, i.e., the intellectual construct of the operational database management system, client server, client host, and customer access in a four-tiered architecture to manage asynchronous data exchanges as described in section 4.3.1;
b. the turnkey rack-mount system concept of operations, i.e., the intellectual construct of the operational database management system, client server, client host, and customer access in a four-tiered architecture to manage asynchronous data exchanges as described in section 4.3.1;
c. the key software components, i.e., the intellectual construct of the encapsulation, persistence, and universality of data objects that are managed by classes to ensure a primary and secondary data stream flow as described in section 4.3.2;
d. the validation and verification concepts, i.e., the intellectual construct of the operational software validation classes as described in section 4.3.3;
e. the upgrade and maintenance strategy, i.e., the intellectual construct of modularity as described in section 4.3.4; and
f. the risk management strategy, i.e., the intellectual construct of the managing top level critical risk areas as described in section 4.3.5 and listed in Table 8; and

6. the symbols, abbreviations, and acronyms as related to SOLAR2000 definitions and described in the Glossary section.
